(19) United States
(12) Patent Application Publication
(10) Pub. No.: US 2017/0339159 A1
(43) Pub. Date: Nov. 23, 2017

(54) REGISTERING APPARATUS, TERMINAL APPARATUS, REGISTERING METHOD, AND NON-TRANSITORY COMPUTER READABLE STORAGE MEDIUM

(71) Applicant: YAHOO JAPAN CORPORATION, Tokyo (JP)

(72) Inventors: Hidehito GOMI, Tokyo (JP); Teruhiko TERAOKA, Tokyo (JP); Wataru OGAMI, Tokyo (JP)

(73) Assignee: YAHOO JAPAN CORPORATION, Tokyo (JP)

(21) Appl. No.: 15/454,300

(22) Filed: Mar. 9, 2017

(30) Foreign Application Priority Data
May 19, 2016 (JP) 2016-100814

(51) Int. Cl. H04L 29/06

(52) U.S. Cl. CPC H04L 63/104; H04L 63/083

(57) ABSTRACT

A registering apparatus disclosed herein includes a receiving unit and a registering unit. The receiving unit receives a registration request that is transmitted from a first terminal apparatus of which reliability has been verified on the basis of a predetermined rule and that is a request including certification indicating that a second terminal apparatus is trusted by the first terminal apparatus on the basis of a rule held in the first terminal apparatus. The registering unit registers the second terminal apparatus, when the receiving unit has received the registration request.

### CROSS-REFERENCE TO RELATED APPLICATION(S)

The present application claims priority to and incorporates by reference the entire contents of Japanese Patent Application No. 2016-100814 filed in Japan on May 19, 2016.

### BACKGROUND OF THE INVENTION

### 1. Field of the Invention

The present invention relates to a registering apparatus, a terminal apparatus, a registering method, and a non-transitory computer readable storage medium having stored therein a registering computer program.

### 2. Description of the Related Art

In recent years, communication networks have become popular, and services mediated by networks are offered in abundance. For example, by using a terminal apparatus, a user registers user information with a service offered via a network. After that, when using the service, the user attempts to log into the service on the basis of the registered user information and, after going through a user authentication process performed by the service, the user uses the service.

In this situation, as a technique for performing an authentication process in a network, a method is known by which the authentication process is performed not by a use terminal used for using a service, but by an authenticating terminal that performs the authentication process, so that the service is used through the use terminal on the basis of information obtained from the authenticating process performed in this manner (see Japanese Laid-open Patent Publication No. 2009-118110).

However, according to the conventional technique described above, it is difficult to perform the registering process with an excellent level of convenience. For example, since communication networks have become popular, there are situations where a single user uses services or obtains various types of information, while using a plurality of mutually-different terminals. In those situations, according to the conventional technique described above, when the user wishes to use the plurality of terminals as authenticating terminals, the user needs to register each of the plurality of terminals with the service offering side. Further, because the user needs to take the trouble of performing a registering process for each of the services he/she wishes to use, the registering processes required at the times of use of the services may become a burden. In that situation, there is a possibility that some of the services may be prevented from becoming popular.

### SUMMARY OF THE INVENTION

It is an object of the present invention to at least partially solve the problems in the conventional technology.

An A registering apparatus according to the present application includes a receiving unit that receives a registration request that is transmitted from a first terminal apparatus of which reliability has been verified on a basis of a predetermined rule and that is a request including certification indicating that a second terminal apparatus is trusted by the first terminal apparatus on a basis of a rule held in the first terminal apparatus, and a registering unit that registers the second terminal apparatus, when the receiving unit has received the registration request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a drawing illustrating an example of a registering process according to an embodiment;

FIG. 2 is a diagram illustrating an exemplary configuration of a registering system according to the embodiment;

FIG. 3 is a diagram illustrating an exemplary configuration of a registering apparatus according to the embodiment;

FIG. 4 is a drawing illustrating an example of a trust policy storage unit according to the embodiment;

FIG. 5 is a drawing illustrating an example of a registered device storage unit according to the embodiment;

FIG. 6 is a diagram illustrating an exemplary configuration of a user terminal according to the embodiment;

FIG. 7 is a drawing illustrating an example of another trust policy storage unit according to the embodiment;

FIG. 8 is a drawing illustrating an example of a registration information storage unit according to the embodiment;

FIG. 9 is a first sequence chart illustrating a processing procedure according to the embodiment;

FIG. 10 is a second sequence chart illustrating another processing procedure according to the embodiment;

FIG. 11 a first drawing for explaining an example of a registering process according to a modification example;

FIG. 12 is a second drawing for explaining another example of a registering process according to another modification example;

FIG. 13 is a third drawing for explaining yet another example of a registering process according to yet another modification example; and

FIG. 14 is a hardware configuration diagram illustrating an example of a computer that realizes functions of the registering apparatus.

### DETAILED DESCRIPTION OF THE PREFERRED EMBODIMENTS

Exemplary embodiments (hereinafter, “embodiments”) to realize a registering apparatus, a terminal apparatus, a registering method, and a non-transitory computer readable storage medium having stored therein a registering computer program of the present application will be explained in detail below, with reference to the accompanying drawings. The registering apparatus, the terminal apparatus, the registering method, and the non-transitory computer readable storage medium having stored therein the registering computer program of the present application are not limited by the embodiments. Further, it is possible to combine any of the embodiments together, as appropriate, as long as no conflict arises among the contents of the processes. Also, in the embodiments described below, the same elements will be referred to by using the same reference characters, and duplicate explanations will be omitted.

1. An Example of a Registering Process

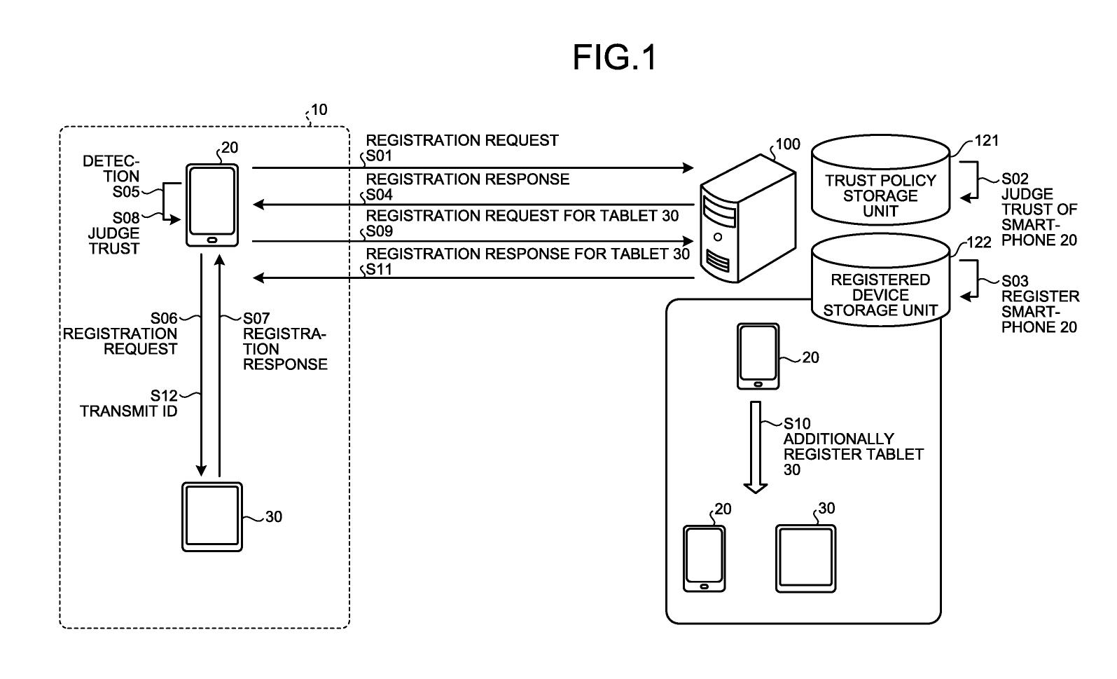

First, an example of a registering process according to an embodiment will be explained, with reference to FIG. 1. FIG. 1 is a drawing illustrating the example of the registering process according to the embodiment. FIG. 1 illustrates an example of a process in which a plurality of devices possessed by a user (which will collectively be referred to as “user terminals 10” when there is no need to distinguish the devices from one another) are registered by a registering apparatus 100 that corresponds to a registering apparatus of the present application and that is configured with a server apparatus.

In the present embodiment, “to register” denotes to cause a server to store therein information about a device for the purpose of enjoying a predetermined service offered by the server. For example, for the purpose of using a service offered by the registering apparatus 100 or a registering apparatus connected to the registering apparatus 100, the user who uses the user terminals 10 registers the user terminals 10. After the user terminals 10 have been registered, when using the service, each of the user terminals 10 accesses the registering apparatus 100 and transmits credential information issued at the time of the registration, to the registering apparatus 100. An example of the credential information is a pass code. When having confirmed that the credential information transmitted thereto from any one of the user terminals 10 is the same as the credential information issued at the time of the registration of the user terminal 10, the registering apparatus 100 authenticates the user terminal 10. In other words, the user terminal 10 obtains a right to use the predetermined service, by being authenticated by the registering apparatus 100.

As explained above, to use the services in the network, the user is required to perform the registering process with the server that offers the services (or an apparatus that manages registering and authenticating processes). However, there are many situations where a single user possesses two or more devices, and it takes a lot of trouble to perform the registering process of all of the devices.

To cope with these situations, the registering apparatus 100 and the user terminals 10 of the present application are configured to perform a registering process with an excellent level of convenience, by performing processes described below. Next, a flow in the registering process performed by the registering apparatus 100 and the user terminals 10 will be explained, with reference to FIG. 1.

With reference to FIG. 1, a smartphone 20 and a tablet 30 will be used in the explanation as examples of the user terminals 10. In other words, the smartphone 20 and the tablet 30 are assumed to be devices possessed by mutually-the-same user. In the following explanations, a device such as the smartphone 20 that transmits a registration request related to another device may be referred to as a “first terminal apparatus”. In contrast, a device such as the tablet 30 that causes a registration request related thereto to be transmitted via another device may be referred to as a “second terminal apparatus”.

First, the smartphone 20 transmits a registration request to the registering apparatus 100 (step S01). By using a predetermined trust policy, the registering apparatus 100 judges trust (reliability) of the smartphone 20 (step S02). In the present embodiment, the trust policy is a rule used for judging the trust of devices to be registered by the registering apparatus 100. In other words, the registering apparatus 100 judges whether or not the smartphone 20 that has transmitted the registration request thereto is a device that is compliant with the trust policy stored in a trust policy storage unit 121. In that situation, the registering apparatus 100 may obtain the information used for judging whether or not the smartphone 20 is compliant with the trust policy, from the smartphone 20 that transmitted the registration request.

After that, when the smartphone 20 is compliant with the trust policy, the registering apparatus 100 verifies the trust of the smartphone 20 that transmitted the registration request thereto and registers the smartphone 20 (step S03). As explained in detail later, the trust policy according to the present embodiment is, for example, a rule indicating manufacturers by which devices are manufactured or functions realized by the devices (e.g., protocols with which the devices are compatible).

The registering apparatus 100 stores the registered device into a registered device storage unit 122. At the point in time of step S03, the registering apparatus 100 registers the smartphone 20. When having registered the smartphone 20, the registering apparatus 100 responds with information about the registration (step S04). For example, the registering apparatus 100 transmits unique identification information (an ID) to be used in future authentication processes and credential information to be paired up with the ID, to the smartphone 20. For example, as the credential information, the registering apparatus 100 transmits a pass code or the like having a predetermined number of characters, to the smartphone 20.

In this situation, let us discuss a situation in which the user who uses the smartphone 20 and the tablet 30 wishes to use the service offered by the registering apparatus 100 not only on the smartphone 20, but also on the tablet 30. In that situation, the user operates the smartphone 20 so as to cause the smartphone 20 to perform a predetermined detecting process. Alternatively, the smartphone 20 may perform the predetermined device detecting process, without receiving the operation performed by the user.

For example, the smartphone 20 performs a process of detecting a device positioned in the vicinity thereof (step S05). For example, the smartphone 20 detects the device positioned in the vicinity thereof, by detecting a radio wave of WiFi (registered trademark) or Bluetooth (registered trademark) or by detecting a device using the same access point. As a result of the process, the smartphone 20 detects the tablet 30.

After that, the smartphone 20 transmits a registration request to the tablet 30 (step S06). In this situation, the registration request includes a request that is transmitted from the smartphone 20 to the tablet 30 and is used for causing terminal information of the tablet 30 to be transmitted to the smartphone 20. In other words, the registration request in this situation indicates that the smartphone 20 requests the tablet 30 to transmit the terminal information thereof, for the purpose of arranging the tablet 30 to be registered by a certain apparatus.

The tablet 30 responds to the registration request from the smartphone 20 (step S07). More specifically, the tablet 30 transmits the terminal information of the tablet 30. For example, the tablet 30 responds to the smartphone 20 with information indicating the manufacturer by which the tablet 30 was manufactured or information indicating functions realized by the tablet 30.

Subsequently, on the basis of the information transmitted thereto from the tablet 30, the smartphone 20 judges trust of the tablet 30 (step S08). For example, the smartphone 20 judges the trust of the tablet 30, according to a trust policy held therein.

By using standards in the trust policy held therein, for example, the smartphone 20 judges whether or not the tablet 30 is a terminal apparatus meeting the standards. In other words, the smartphone 20 judges whether or not it is possible to verify the trust of the tablet 30. In the example illustrated in FIG. 1, let us assume that the smartphone 20 has determined that the tablet 30 is a trustworthy device. In that situation, the smartphone 20 transmits a registration request for the tablet 30 to the registering apparatus 100 (step S09). At this time, on the basis of the trust policy held therein, the smartphone 20 arranges the registration request to include information (e.g., a signature) certifying that the tablet 30 is trusted. The trust policy held in the smartphone 20, for example, may have standards equivalent to those of the trust policy held in the registering apparatus 100.

When having received the registration request for the tablet 30 from the smartphone 20, the registering apparatus 100 analyzes the certification indicating that the tablet 30 is trusted by the smartphone 20. For example, the registering apparatus 100 verifies the signature appended to the registration request by the smartphone 20. After that, when having determined that the signature appended by the smartphone 20 is trustworthy, the registering apparatus 100 additionally registers the tablet 30 (step S10).

In that situation, by using a concept of a trust network, which is a network formed among trusted apparatuses, the registering apparatus 100 may perform a process of registering the smartphone 20 and the tablet 30 into mutually-the-same trust network. In other words, the registering apparatus 100 additionally registers the tablet 30 into the trust network formed by the smartphone 20. For example, the registering apparatus 100 may perform a process of offering mutually-the-same service to devices belonging to mutually-the-same trust network. For example, when devices belonging to mutually-the-same trust network have logged into a service, the registering apparatus 100 may perform a process of providing a log-in screen that is in common among the devices.

When having registered the tablet 30, the registering apparatus 100 responds to the smartphone 20 by indicating that the tablet 30 has been registered (step S11). In that situation, the registering apparatus 100 issues an ID and credential information, in the same manner as when registering the smartphone 20. After that, the registering apparatus 100 transmits the ID and the credential information that were issued, to the smartphone 20.

When having obtained the ID and the credential information, the smartphone 20 transmits the obtained ID and credential information, to the tablet 30 (step S12). From this point in time, the tablet 30 is able to use any of the services offered by the registering apparatus 100, by performing an authentication process with the registering apparatus 100 while using the ID and the credential information received from the smartphone 20.

As explained above, the registering apparatus 100 according to the embodiment receives the registration request that is transmitted thereto from the first terminal apparatus of which the reliability has been verified on the basis of the trust policy serving as the predetermined rule and that is a request including the certification indicating that the second terminal apparatus (the tablet 30) is trusted by the first terminal apparatus on the basis of the rule held in the first terminal apparatus. After that, when having received the registration request, the registering apparatus 100 registers the second terminal apparatus.

As explained above, when registering devices, the registering apparatus 100 according to the present embodiment does not require that all of the registering process be performed on the registering apparatus 100 (the server) side. Instead, when the second terminal apparatus trusted by the first terminal apparatus is present, the registering apparatus 100 is able to register the second terminal apparatus. In other words, the registering apparatus 100 is capable of judging the trust of the first terminal apparatus and is also capable of accepting the registration of the second terminal apparatus of which the trust was communicated from the first terminal apparatus. As a result of this process, because the user is able to save the trouble of causing all the devices in possession to access the registering apparatus 100 to perform the registering process, the user is able to perform the registering processes conveniently. Further, when the first terminal apparatus is configured so as to automatically detect any device positioned in the vicinity thereof, the user is able to have the registering process performed by each of the devices autonomously and automatically. Accordingly, it is possible to automatically increase the number of devices that are able to use the services related to the registering apparatus 100. In addition, the first terminal apparatus holds the trust policy therein and judges the trust of the second terminal apparatus according to the policy. In other words, the first terminal apparatus judges the trust of the second terminal apparatus by using the standards equivalent to those used when the registering apparatus 100 judged the trust of the first terminal apparatus. Consequently, by performing the registering process according to the present embodiment, it is possible to perform a registering process while ensuring security. As explained herein, the registering apparatus 100 according to the embodiment is able to perform the registering process with an excellent level of convenience for the user.

2. A Configuration of a Registering System

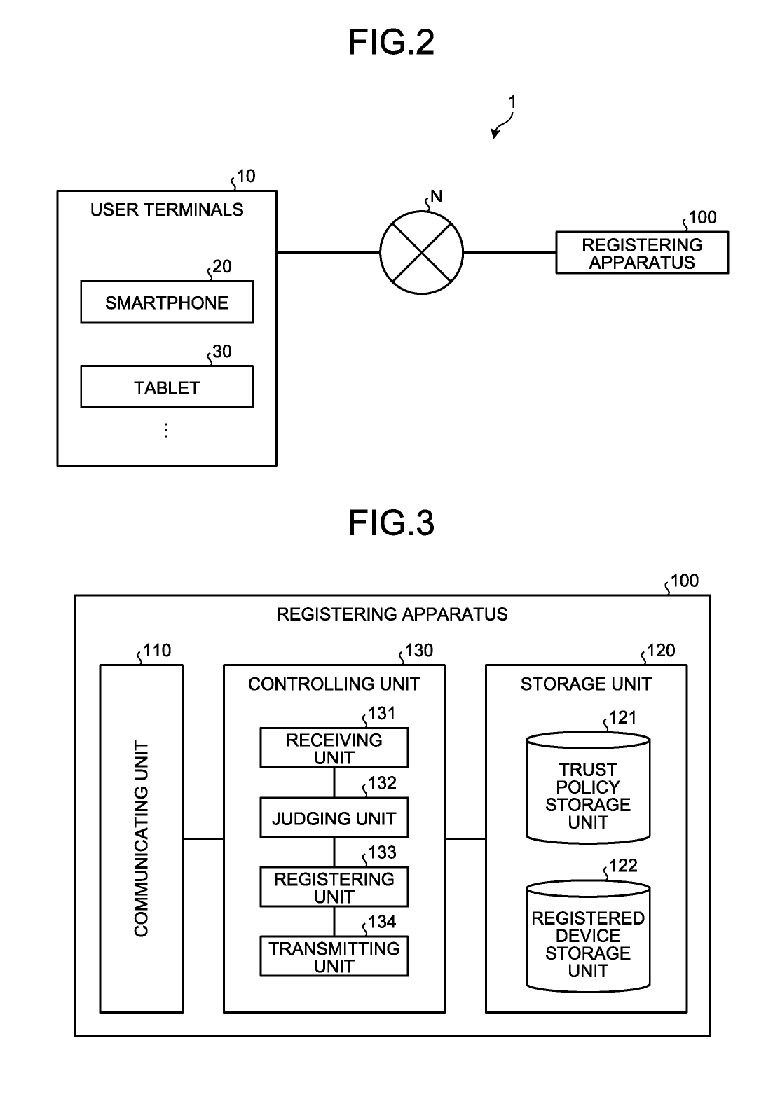

Next, a configuration of a registering system 1 including the registering apparatus 100 according to the present embodiment will be explained, with reference to FIG. 2. FIG. 2 is a diagram illustrating an exemplary configuration of the registering system 1 according to the embodiment. As illustrated in FIG. 2, the registering system 1 according to the embodiment includes the user terminals 10 and the registering apparatus 100. Further, the user terminals 10 include the smartphone 20, the tablet 30, and so on. These various types of apparatuses are connected via a network N so as to be able to communicate with one another in a wired or wireless manner.

For example, each of the user terminals 10 is an information processing terminal (“a device”) such as a desktop Personal Computer (PC), a notebook PC, a tablet terminal, a mobile phone which may be a smartphone, a Personal Digital Assistant (PDA), or the like. Further, the user terminals 10 may include wearable devices such as a watch-type terminal or an eyeglass-type terminal. Further, the user terminals 10 may include various types of smart devices each having an information processing function. For example, the user terminals 10 may include smart home electric appliances such as a television (TV), smart vehicles such as an automobile, drones, home-use robots, and the like.

The registering apparatus 100 is a server apparatus that registers the user terminals 10 on the basis of the predetermined trust policy. Further, when having received, from an already-registered user terminal 10, the registration request indicating that another device is trusted thereby, the registering apparatus 100 registers the trusted device. In other words, on the basis of the communicated trust, the registering apparatus 100 is able to register the new device, in addition to the user terminal 10 that has already been registered.

The registering apparatus 100 may also have a function of a web server that offers various types of services. Further, the registering apparatus 100 may also function as an authentication management apparatus that, after going through an authentication process performed on any of the user terminals 10, allows the user terminal 10 to access the web server offering the various types of services (to use any of the various types of services).

3. A Configuration of the Registering Apparatus

Next, a configuration of the registering apparatus 100 according to the embodiment will be explained, with reference to FIG. 3. FIG. 3 is a diagram illustrating an exemplary configuration of the registering apparatus 100 according to the embodiment. As illustrated in FIG. 3, the registering apparatus 100 includes a communicating unit 110, a storage unit 120, and a controlling unit 130. Further, the registering apparatus 100 may include an input unit (e.g., a keyboard and/or a mouse) that receives various types of operations from an administrator or the like who uses the registering apparatus 100, a display unit (e.g., a liquid crystal display device) that displays various types of information, and/or the like.

The Communicating Unit 110

The communicating unit 110 may be realized with a Network Interface Card (NIC), for example. The communicating unit 110 is connected to the network N in a wired or wireless manner and is configured to transmit and receive information to and from any of the user terminals 10 via the network N.

The Storage Unit 120

For example, the storage unit 120 may be realized with a semiconductor memory element such as a Random Access Memory (RAM), a flash memory, or the like, or a storage device such as a hard disk, an optical disk, or the like. The storage unit 120 includes the trust policy storage unit 121 and the registered device storage unit 122.

The Trust Policy Storage Unit 121

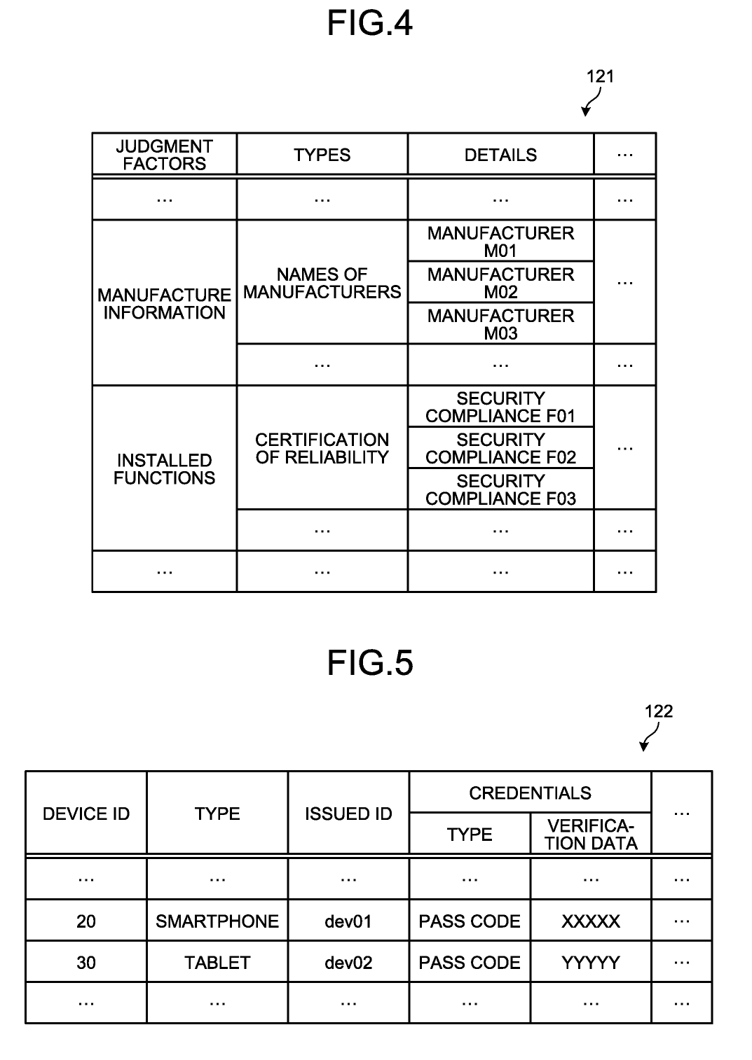

The trust policy storage unit 121 stores therein the trust policy used for judging the reliability of any of the user terminals 10 when registering the user terminal 10. FIG. 4 illustrates an example of the trust policy storage unit 121 according to the embodiment. FIG. 4 is a drawing illustrating the example of the trust policy storage unit 121 according to the embodiment. In the example illustrated in FIG. 4, the trust policy storage unit 121 has items such as “judgment factors”, “types”, and “details”.

Shown under the item “judgment factors” are factors used for judging the reliability of any of the user terminals 10. For example, each of the judgment factors may be information such as “manufacture information” or “installed functions”. The manufacture information represents information related to the manufacture of the user terminals 10. The installed functions represent information related to functions realized by the user terminals 10.

Shown under the item “types” are types of the judgment factors. For example, when a judgment factor is manufacture information, the “types” may include “names of manufacturers”. It means that whether a user terminal 10 is trusted or not is determined depending on what manufacturer manufactured the user terminal 10. Further, when a judgment factor is installed functions, the “types” may include “certification of reliability”. The “certification of reliability” represents, with regard to the functions realized by the user terminal 10, information indicating what functions are installed as the functions that certify the reliability of the user terminal 10 itself.

Shown under the item “details” are details related to each of the judgment factors. For example, under the type of the judgment factor “names of manufacturers”, when the details are indicated as “manufacturer M01”, it means that a user terminal 10 manufactured by the manufacturer M01 is granted with certain level of reliability according to the trust policy.

Further, under the type of the judgment factor “certification of reliability”, when the details are indicated as “security compliance F01”, it means that a user terminal 10 satisfying the security compliance F01 is granted with certain level of reliability according to the trust policy. FIG. 4 illustrates the example in which conceptual information such as the “security compliance F01” is stored as the details of the certification of reliability; however, in actuality, as the details of the certification of reliability, the stored information indicates a device being compatible with a protocol that satisfies a specific security specification and/or a device being capable of generating encrypted information standardized by a specific institution.

In other words, FIG. 4 indicates that the trust policy held by the registering apparatus 100 includes judgment factors such as the “manufacture information” and the “installed functions”, as the judgment factors. Further, the item “manufacture information” includes the type called “names of manufacturers” and indicates that, for example, devices manufactured by the manufacturers named “manufacturer M01”, “manufacturer M02” and “manufacturer 03” are granted with certain level of reliability. Further, the item “installed functions” includes the type called “certification of reliability” and indicates that, for example, when a device has (when a device is compatible with) a function such as “security compliance F01”, “security compliance F02”, or “security compliance F03”, the device is granted with certain level of reliability. In this situation, the trust policy storage unit 121 may store therein a judgment factor to which a predetermined signature is appended. In other words, the trust policy storage unit 121 may store therein the judgment factor that has appended thereto a signature certifying that a device was manufactured by the “manufacturer M01” or a signature on accreditation information indicating that the “security compliance F02” is accredited. Further, the registering apparatus 100 may perform the process of verifying the trust of any of the user terminals 10 by verifying these signatures.

The Registered Device Storage Unit 122

The registered device storage unit 122 stores therein information about the devices registered by the registering apparatus 100. FIG. 5 illustrates an example of the registered device storage unit 122 according to the embodiment. FIG. 5 is a drawing illustrating the example of the registered device storage unit 122 according to the embodiment. In the example illustrated in FIG. 5, the registered device storage unit 122 has items such as “device ID”, “type”, “issued ID”, and “credentials”. Further, the item “credentials” has sub-items such as “type” and “verification data”.

Shown under the item “device ID” is identification information of each of the devices registered by the registering apparatus 100. In the present embodiment, it is assumed that the device IDs are the same as the reference numerals of the devices. For example, the device identified with the device ID “20” is the smartphone 20. Similarly, the device identified with the device ID “30” is the tablet 30.

Shown under the item “type” is the type of each of the devices. Shown under the item “issued ID” is the identification information issued to each of the devices, when the registering apparatus 100 has registered the device.

Shown under the item “credentials” is information used for authenticating each of the registered devices. Shown under the sub-item “type” is the type of the information used as a credential. For example, examples of the “type” include pass codes, biological information, hardware tokens, and the like. Shown under the sub-item “verification data” are pieces of data each of which is used for verifying the authenticity of a different one of the registered devices. For example, the verification data may be a character string such as “XXXXX” when a pass code is being used and may be fingerprint data of the user who uses the device when biological information is being used.

In other words, FIG. 5 indicates that the devices registered by the registering apparatus 100 are the devices having the identification information such as “20” and “30”, while the types thereof are “smartphone” and “tablet”, respectively. Further, FIG. 5 also indicates that the ID issued for the registration of the smartphone 20 is “dev01”. Also, FIG. 5 indicates that the type of the credential used when the smartphone 20 is authenticated is a “pass code”, while the verification data of the pass code is “XXXXX”.

The Controlling Unit 130

For example, the controlling unit 130 is a controller and is realized as a result of causing various types of computer programs (corresponding to an example of the registering computer program according to an embodiment) that are stored in a storage device provided within the registering apparatus 100 to be executed by a Central Processing Unit (CPU), a Micro Processing Unit (MPU), or the like, while using a RAM as a working area. Alternatively, the controlling unit 130 is a controller and may be realized, for example, by using an integrated circuit such as an Application Specific Integrated Circuit (ASIC), a Field Programmable Gate Array (FPGA), or the like.

As illustrated in FIG. 3, the controlling unit 130 includes a receiving unit 131, a judging unit 132, a registering unit 133, and a transmitting unit 134 and is configured to realize or to execute functions and operations of the information processing processes described below. The internal structure of the controlling unit 130 is not limited to the configuration illustrated in FIG. 3. As long as the information processing processes described below can be realized, the controlling unit 130 may have another configuration. Further, the connection relationship among the processing units included in the controlling unit 130 is not limited to the connection relationship illustrated in FIG. 3. The processing units may have another connection relationship.

The Receiving Unit 131

The receiving unit 131 is configured to receive various types of information. For example, the receiving unit 131 receives a request for being registered by the registering apparatus 100, from the smartphone 20, which is an example of the user terminals 10.

Further, the receiving unit 131 receives the registration request that is transmitted thereto from the smartphone 20 of which the reliability has been authenticated on the basis of the predetermined rule and that is a request including the certification indicating that another user terminal 10 (e.g., the tablet 30) different from the smartphone 20 is trusted by the smartphone 20 on the basis of a rule held in the smartphone 20. In other words, the receiving unit 131 receives not only direct registration requests, but also the indirect registration request that is related to the tablet 30 and that is transmitted thereto from the smartphone 20 which has already been registered.

When receiving the registration requests, the receiving unit 131 receives the information about the smartphone 20 that transmitted the registration request thereto and about the tablet 30 requesting to be newly registered. For example, the receiving unit 131 receives the identification information of the smartphone 20, as well as the information indicating the type of the device, the manufacture information, the functions installed in the device, and the like.

The Judging Unit 132

The judging unit 132 is configured to judge the reliability of the registration request received by the receiving unit 131. For example, the judging unit 132 judges reliability as to whether or not the smartphone 20 requesting the registration is a trustworthy terminal apparatus.

The judging unit 132 judges the reliability according to the trust policy serving as the predetermined rule. For example, the judging unit 132 judges whether or not the smartphone 20 having transmitted the registration request has conditions compliant with one or more factors to be determined as a trustworthy terminal apparatus according to the trust policy. In that situation, the judging unit 132 may judge the reliability by using a single factor or may judge the reliability by scoring two or more factors.

Further, with respect to a registration request that was transmitted from the smartphone 20 and that includes information indicating that the reliability of the tablet 30 is certified by the smartphone 20, the judging unit 132 may judge reliability related to the origin of the transmission as to whether the registration request was truly transmitted from the smartphone 20.

For example, when the certification included in the registration request certifies that the tablet 30 is trusted by the smartphone 20 on the basis of a rule having a standard equivalent to that of the trust policy held in the registering apparatus 100, the judging unit 132 may determine the tablet 30 to be a trustworthy terminal apparatus. In other words, when the smartphone 20 has a trust policy having the standard equivalent to that of the registering apparatus 100 while the trust policy is used for judging the tablet 30, the judging unit 132 determines the tablet 30 to be a trustworthy terminal apparatus. In other words, the judging unit 132 judges whether or not the reliability of the terminal apparatus in question was judged by another terminal apparatus to which the trust policy used by the registering apparatus 100 has properly been communicated.

In this situation, the judging unit 132 may simplify the judging process by trusting processes performed by the smartphone 20 that has already been registered. For example, without the need to judge the trust policy in the manner described above, the judging unit 132 may judge whether or not the certification included in the registration request is based on predetermined communication established between the smartphone 20 and the tablet 30.

After that, when the certification included in the registration request is based on the predetermined communication, the judging unit 132 may trust the registration request transmitted from the smartphone 20 so as to determine the tablet 30 to be a trustworthy terminal apparatus. The predetermined communication may be, for example, short distance communication (e.g., Bluetooth) that is based on pairing and is established between the smartphone 20 and the tablet 30.

In other words, when communication has been established between the smartphone 20 and the tablet 30, the judging unit 132 conjectures that the smartphone 20 and the tablet 30 are terminal apparatuses that are in a close relationship with each other such as being possessed by mutually-the-same user and therefore trusts the registration request transmitted from the smartphone 20. In that situation, because the judging unit 132 is able to simplify the judging process, it is possible to reduce the processing load. Further, for example, by using communication being established between the first terminal apparatus and the second terminal apparatus as a judgment factor, the judging unit 132 is able to ensure a certain level of reliability even if it is unknown what trust policy was used by the first terminal apparatus to judge the second terminal apparatus. It is therefore possible to perform a secure registering process.

The Registering Unit 133

The registering unit 133 is configured to register one or more of the user terminals 10 on the basis of the predetermined rule. For example, the registering unit 133 registers the smartphone 20 (the first terminal apparatus) on the basis of the trust policy stored in the trust policy storage unit 121. More specifically, the registering unit 133 registers the smartphone 20, when the judging unit 132 has authenticated the reliability of the smartphone 20 on the basis of the predetermined rule.

Further, the registering unit 133 registers the tablet 30 when a registration request has been received, the registration request including certification indicating that the tablet 30 (the second terminal apparatus) is trusted by the smartphone 20 on the basis of a rule held in the smartphone 20.

When the judging unit 132 has determined the user terminal 10 related to the registration request to be a trustworthy terminal apparatus by judging the reliability of the registration request or the reliability of the certification indicating that the second terminal apparatus is trusted by the first terminal apparatus, the registering unit 133 may register the user terminal 10.

For example, when the certification included in the registration request certifies that the second terminal apparatus is trusted by the first terminal apparatus on the basis of a rule having a standard equivalent to that of the trust policy stored in the trust policy storage unit 121, the registering unit 133 may register the second terminal apparatus.

Further, when registering any of the user terminals 10, the registering unit 133 issues unique identification information and credential information to each of the user terminals 10. When a user terminal 10 makes an access after being registered, the registering unit 133 requests the user terminal 10 to present the unique identification information and the credential information that were issued at the time of registration. After that, the registering unit 133 authenticates the user terminal 10 that presents the unique identification information and the credential information that are correct. When having been authenticated, the user terminal 10 gains a right to use the services or the like offered by the registering apparatus 100, for example.

Alternatively, the registering unit 133 may be configured to issue identification information to the second terminal apparatus via the first terminal apparatus, the identification information being issued at the time of the registration and being unique and used when the second terminal apparatus accesses the registering apparatus 100. In other words, the registering unit 133 forwards the unique identification information and the credential information to the second terminal apparatus via the first terminal apparatus. With this arrangement, even in a situation where it is difficult for the second terminal apparatus to directly communicate with the registering apparatus 100 or where the second terminal apparatus is unable to directly receive the unique identification information and the credential information, the registering unit 133 is able to register the second terminal apparatus without any problem.

The Transmitting Unit 134

The transmitting unit 134 is configured to transmit various types of information. For example, to a user terminal 10 that transmitted a registration request, the transmitting unit 134 transmits a response related to the registration. As the response, the transmitting unit 134 transmits information indicating that the registering process has been completed and the unique identification information and the credential information issued at the time of the registration, to the user terminal 10.

4. A Configuration of the User Terminals 10

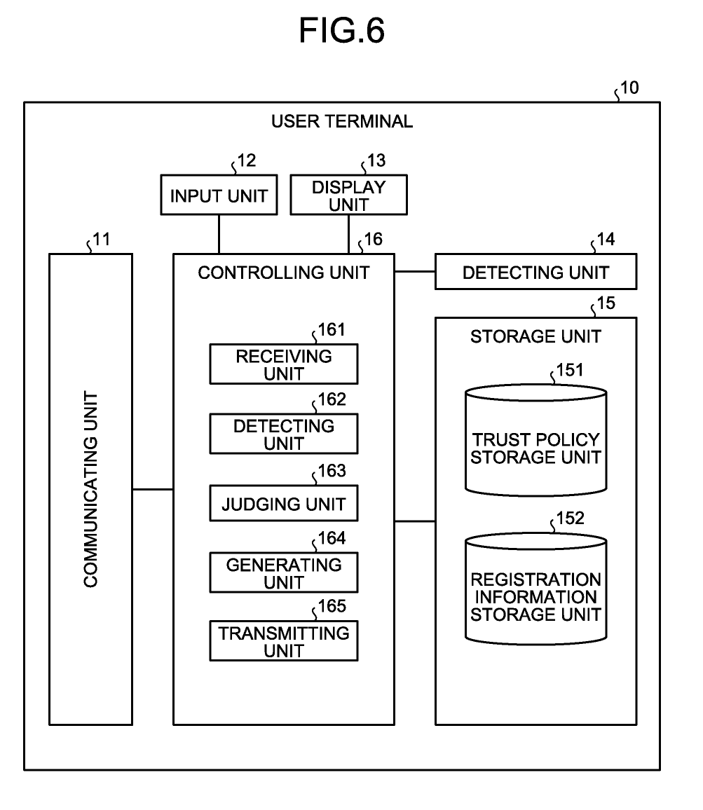

Next, a configuration of a user terminal 10 according to the embodiment will be explained, with reference to FIG. 6. FIG. 6 is a diagram illustrating an exemplary configuration of the user terminal 10 according to the embodiment. As illustrated in FIG. 6, the user terminal 10 includes a communicating unit 11, an input unit 12, a display unit 13, a detecting unit 14, a storage unit 15, and a controlling unit 16.

The Communicating Unit 11

The communicating unit 11 is realized by using an NIC or the like, for example. The communicating unit 11 is connected to the network N in a wired or wireless manner and is configured to transmit and receive information to and from the registering apparatus 100 and an arbitrary device, via the network N.

The Input Unit 12 and the Display Unit 13

The input unit 12 is an input device configured to receive various types of operations from the user. For example, the input unit 12 is realized with operation keys or the like provided for the user terminal 10. The display unit 13 is a display device used for displaying various types of information. For example, the display unit 13 is realized by using a liquid crystal display or the like. When a touch panel is adopted in the user terminal 10, a part of the input unit 12 and the display unit 13 are integrally formed.

The Detecting Unit 14

The detecting unit 14 is configured to detect various types of information related to the user terminal 10. More specifically, the detecting unit 14 detects an operation performed on the user terminal 10 by the user, position information indicating the position in which the user terminal 10 is present, information about a device connected to the user terminal 10, an environment of the user terminal 10, and the like.

For example, the detecting unit 14 detects the operation performed by the user, on the basis of information input to the input unit 12. In other words, the detecting unit 14 detects that an operation of touching a screen is input or a sound/voice is input to the input unit 12. Further, the detecting unit 14 may also detect that a predetermined application program has been activated by the user. When the activated application program is one that brings an image taking function (e.g., a camera) provided in the user terminal 10 into operation, the detecting unit 14 detects that the image taking function is being used by the user. Further, the detecting unit 14 may also detect an operation of moving the user terminal 10 itself, on the basis of data detected by an acceleration sensor or a gyro sensor provided in the user terminal 10.

Further, the detecting unit 14 is configured to detect a current position of the user terminal 10. More specifically, the detecting unit 14 receives a radio wave sent from a Global Positioning System (GPS) satellite and obtains position information (e.g., a latitude and a longitude) indicating the current position of the user terminal 10 on the basis of the received radio wave.

Further, the detecting unit 14 may obtain the position information by using any of other various methods. For example, when the user terminal 10 has a function equivalent to that of a contactless Integrated Circuit (IC) card used at ticket gates at train stations, retail stores, and the like (or when the user terminal 10 has a function of reading a history from a contactless IC card), the user terminal 10 records therein the position of the use, together with information indicating that a train fare was settled at a station, or the like. The detecting unit 14 detects and obtains the recorded information as the position information. Further, when the user terminal 10 performs communication with a specific access point, the detecting unit 14 may detect position information that is available from the access point. Furthermore, the position information may be obtained by an optical sensor, an infrared sensor, a magnetic sensor, or the like included in the user terminal 10.

Further, the detecting unit 14 is configured to detect an external apparatus connected to the user terminal 10. For example, the detecting unit 14 detects the external apparatus on the basis of a communication packet being mutually exchanged with the external apparatus or a signal or the like emitted by the external apparatus. More specifically, the detecting unit 14 detects a radio wave of WiFi, Bluetooth, or the like used by the external apparatus. Further, when communication has been established with the external apparatus, the detecting unit 14 may detect the type of the connection with the external apparatus. For example, the detecting unit 14 detects whether the external apparatus is connected in a wired manner or through wireless communication. Further, the detecting unit 14 may also detect a communication scheme or the like used in the wireless communication. Furthermore, the detecting unit 14 may detect the external apparatus on the basis of information obtained by a radio wave sensor configured to detect a radio wave or by an electromagnetic wave sensor configured to detect an electromagnetic wave transmitted by the external apparatus. An example of the external apparatus is another device (another one of the user terminals 10) used by the user who is using the user terminal 10 and may be, for example, the smartphone 20 or the tablet 30.

Further, the detecting unit 14 detects the environment of the user terminal 10. By using any of the various types of sensors and functions included in the user terminal 10, the detecting unit 14 detects information about the environment. For example, the detecting unit 14 uses a microphone configured to collect sounds in the surroundings of the user terminal 10, an illuminance sensor configured to detect illuminance in the surroundings of the user terminal 10, an acceleration sensor (or a gyro sensor) configured to detect physical movements of the user terminal 10, a humidity sensor configured to detect humidity in the surroundings of the user terminal 10, a geomagnetic sensor configured to detect a magnetic field in the position where the user terminal 10 is present, and/or the like. Further, by using any of the various types of sensors, the detecting unit 14 detects various types of information. For example, the detecting unit 14 detects a noise level in the surroundings of the user terminal 10 and/or detects whether the illuminance level in the surroundings of the user terminal 10 is suitable for imaging the iris of the user. Furthermore, the detecting unit 14 may detect environment information of the surroundings on the basis of a photo or an image taken by a camera.

Further, on the basis of information detected by the detecting unit 14, the user terminal 10 may be configured to obtain context information indicating a context of the user terminal 10. As explained above, via the various types of sensors (the detecting unit 14) installed therein, the user terminal 10 obtains various types of physical quantities such as a position, an acceleration, a temperature, a gravity value, a rotation (an angular velocity), an illuminance value, a geomagnetic value, a pressure value, a degree of proximity, a humidity level, and/or a rotational vector, as the context information. Further, by using a communication function installed therein, the user terminal 10 may obtain a connection status (e.g., information about establishment of communication or a telecommunication specification being used) with any of various types of apparatuses, as the context information.

The Storage Unit 15

The storage unit 15 stores therein various types of information. For example, the storage unit 15 is realized by using a semiconductor memory element such as a Random Access Memory (RAM), a flash memory, or the like, or a storage device such as a hard disk, an optical disk, or the like. The storage unit 15 includes a trust policy storage unit 151 and a registration information storage unit 152.

The Trust Policy Storage Unit 151

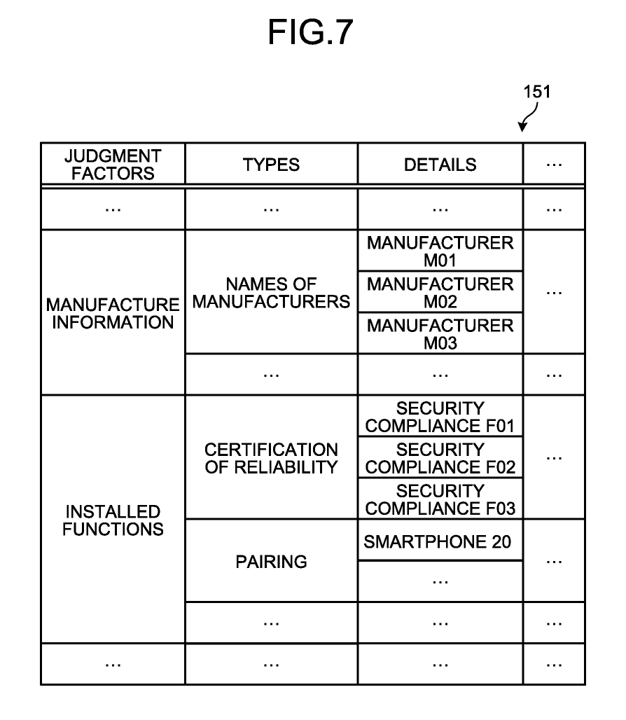

The trust policy storage unit 151 stores therein the trust policy used by the user terminal 10 to judge reliability of another device. FIG. 7 illustrates an example of the trust policy storage unit 151 according to the embodiment. FIG. 7 is a drawing illustrating an example of the trust policy storage unit 151 according to the embodiment. In the example illustrated in FIG. 7, the trust policy storage unit 151 has items such as “judgment factors”, “types”, and “details”. Explanations of some of the items that are the same as those in FIG. 4 will be omitted.

The “pairing” listed under the installed functions indicates examples of types of installed functions judged by the user terminal 10. The example illustrated in FIG. 7 indicates that the user terminal 10 grants a certain level of reliability to a device having a pairing relationship established with a trusted terminal (e.g., the smartphone 20 in the example in FIG. 7), on the basis of the trust policy.

The trust policy storage unit 151 may be configured so as to synchronize with the trust policy stored in the trust policy storage unit 121, by receiving communication from the registering apparatus 100. In other words, an arrangement is acceptable in which the trust policy stored in the trust policy storage unit 151 is the same as the trust policy stored in the trust policy storage unit 121.

The Registration Information Storage Unit 152

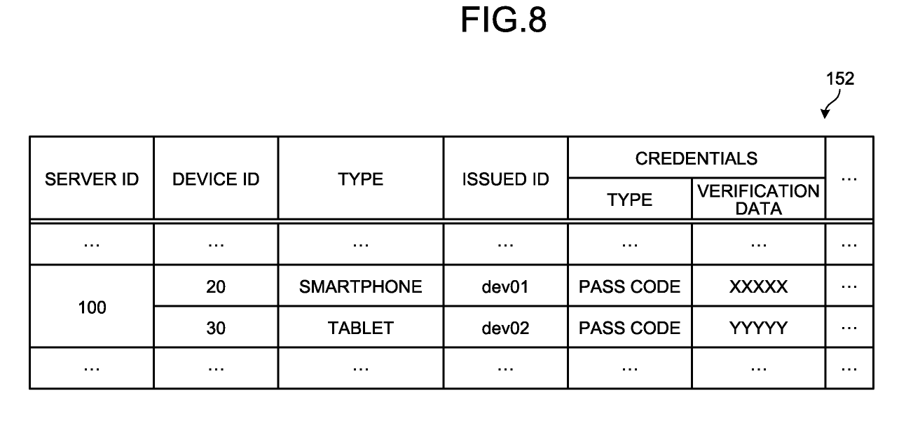

The registration information storage unit 152 stores therein the registration information registered by the registering apparatus 100, with respect to the apparatus thereof and any terminal (the second terminal apparatus) trusted by the apparatus thereof. FIG. 8 illustrates an example of the registration information storage unit 152 according to the embodiment. FIG. 8 is a drawing illustrating an example of the registration information storage unit 152 according to the embodiment. As illustrated in FIG. 8, the registration information storage unit 152 has items such as “server ID”, “device ID”, “type”, “issued ID”, and “credentials”. Further, the item “credentials” has sub-items such as “type” and “verification data”. Explanations of some of the items that are the same as those in FIG. 5 will be omitted.

Shown under the item “server ID” are server apparatuses with which the user terminal 10 has been registered. In other words, the example in FIG. 8 indicates that the user terminal 10 has been registered with the “registering apparatus 100”, that the devices has, as the device IDs thereof, identification information such as “20” and “30”, and that the types of the devices are a “smartphone” and a “tablet”. Further, the example indicates that the ID issued for the registration of the smartphone 20 is “dev01”. Also, the example indicates that the type of the credential to be used when authenticating the smartphone 20 is a “pass code” and that the verification data of the pass code is “XXXXX”.

The Controlling Unit 16

The controlling unit 16 is a controller and is realized, for example, as a result of causing various types of computer programs stored in a storage device provided within the user terminal 10 to be executed by a CPU, an MPU, or the like, while using a RAM as a working area. Alternatively, the controlling unit 16 is a controller and may be realized, for example, by using an integrated circuit such as an ASIC, an FPGA, or the like.

As illustrated in FIG. 6, the controlling unit 16 includes a receiving unit 161, a detecting unit 162, a judging unit 163, a generating unit 164, and a transmitting unit 165 and is configured to realize or to execute functions and operations of the information processing processes described below. The internal structure of the controlling unit 16 is not limited to the configuration illustrated in FIG. 6. As long as the information processing processes described below can be realized, the controlling unit 16 may have another configuration.

The Receiving Unit 161

The receiving unit 161 is configured to receive various types of information. For example, the receiving unit 161 receives information from the registering apparatus 100 indicating that a registration process has been completed, as well as the registration information such as the unique identification information and the credential information issued at the time of the registration from the registering apparatus 100.

The Detecting Unit 162

The detecting unit 162 is configured to detect a second terminal apparatus on the basis of the information detected by the detecting unit 14. In other words, the detecting unit 162 detects a device that requests the registering apparatus 100 to perform a registering process thereon and that has not yet been registered by the registering apparatus 100. In this situation, when detecting the second terminal apparatus, the detecting unit 162 may perform the detecting process on the basis of an operation performed by the user or may perform the detecting process in response to a request from the second terminal apparatus. Further, for example, by using an application program that performs the registering process, the detecting unit 162 may also be configured to perform a process of detecting, as the second terminal apparatus, a device being positioned at a short distance and running the same application program.

The Judging Unit 163

With respect to the second terminal apparatus detected by the detecting unit 162, the judging unit 163 is configured to judge the reliability of the second terminal apparatus on the basis of a predetermined rule. More specifically, the judging unit 163 judges the reliability of the second terminal apparatus on the basis of the trust policy stored in the trust policy storage unit 151.

In that situation, the judging unit 163 may be configured to judge the reliability of the second terminal apparatus by using a trust policy based on a standard equivalent to that of the trust policy held in the registering apparatus 100. In other words, because the second terminal apparatus trusted by the first terminal apparatus is to form a trust network, which is a network where the terminal apparatuses trust each other, it is desirable to configure the first terminal apparatus so as to judge the second terminal apparatus on the basis of the trust policy used at the time when the first terminal apparatus was registered by the registering apparatus 100.

For this reason, the judging unit 163 judges the second terminal apparatus after performing a process of arranging the trust policy held in the apparatus thereof to have a standard equivalent to that of the trust policy held in the registering apparatus 100. For example, the judging unit 163 may perform a process of requesting the registering apparatus 100 to transmit the trust policy thereto and updating the trust policy held in the apparatus thereof. Alternatively, the judging unit 163 may make a request to a predetermined external apparatus and obtain a trust policy compliant with a predetermined specification (e.g., a specification with which the registering apparatus 100 is compliant).

The Generating Unit 164

The generating unit 164 is configured to generate various types of information. For example, when the judging unit 163 has determined that the second terminal apparatus is a trustworthy device, the generating unit 164 generates a registration request including certification that indicates that the second terminal apparatus is trusted and requesting the registering apparatus 100 to register the second terminal apparatus.

Alternatively, when generating the registration request, the generating unit 164 may be configured to perform a process of ensuring reliability by, for example, appending a signature indicating that the registration request was undoubtedly generated by the user terminal 10 (the first terminal apparatus).

The Transmitting Unit 165

The transmitting unit 165 is configured to transmit various types of information. For example, the transmitting unit 165 transmits the registration request that was generated by the generating unit 164 and that includes certification indicating that the second terminal apparatus is trusted, to the registering apparatus 100. Further, when the registering apparatus 100 has registered the second terminal apparatus, the transmitting unit 165 transmits the unique identification information and the credential information issued by the registering apparatus 100 to the second terminal apparatus, to the second terminal apparatus.

5. A Processing Procedure

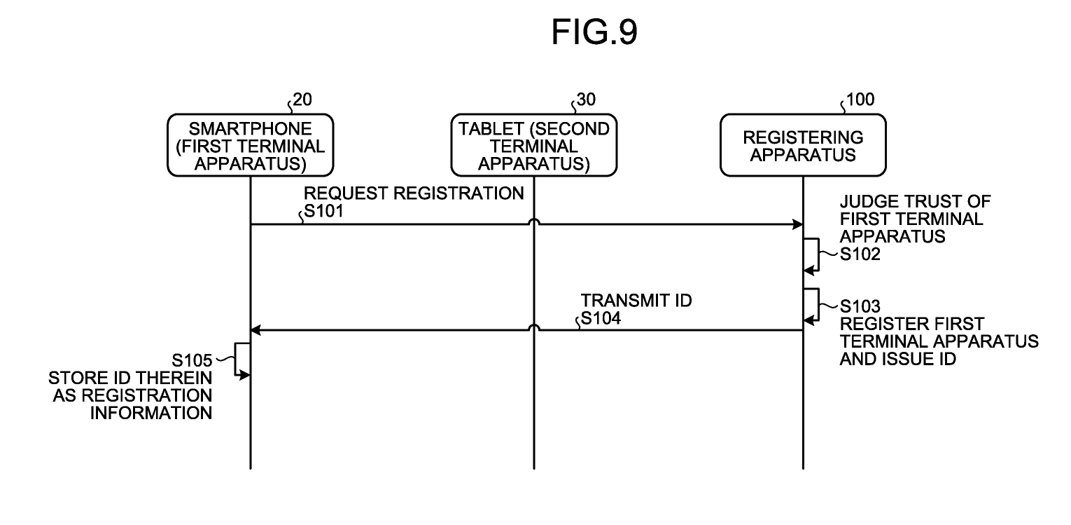

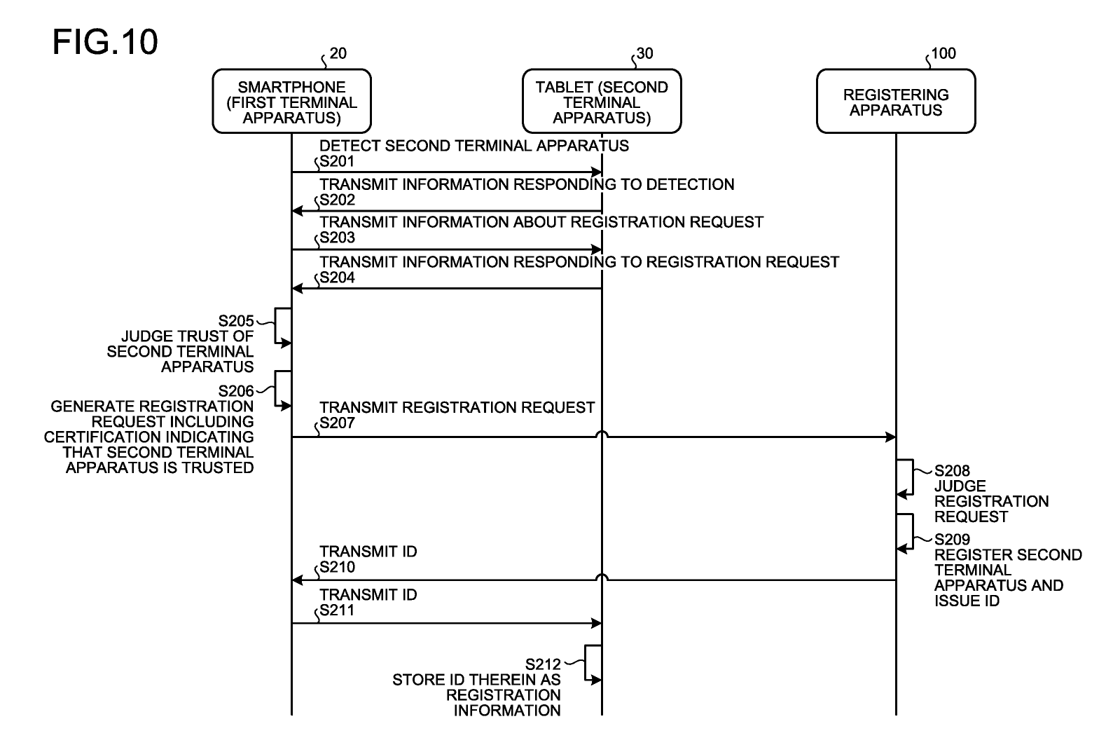

Next, a procedure in a process performed by the registering system 1 according to the embodiment will be explained, with reference to FIGS. 9 and 10. First, a procedure performed by the registering apparatus 100 to register the smartphone 20 serving as a first terminal apparatus will be explained, with reference to FIG. 9. FIG. 9 is a first sequence chart illustrating the processing procedure.

As illustrated in FIG. 9, the first terminal apparatus (the smartphone 20) requests the registering apparatus 100 to perform a registering process (step S101). In other words, the first terminal apparatus transmits a registration request to the registering apparatus 100. When having received the registration request, the registering apparatus 100 judges the trust of the first terminal apparatus on the basis of the trust policy stored in the trust policy storage unit 121 (step S102).

After that, when having determined that the first terminal apparatus is a trustworthy device, the registering apparatus 100 registers the first terminal apparatus. In that situation, the registering apparatus 100 issues unique identification information (an ID) corresponding to the first terminal apparatus (step S103).

The registering apparatus 100 transmits the issued ID to the first terminal apparatus (step S104). The first terminal apparatus stores therein the ID, as registration information (step S105).

Next, a procedure performed by the registering apparatus 100 to register the tablet 30 serving as a second terminal apparatus will be explained, with reference to FIG. 10. FIG. 10 is a second sequence chart illustrating the processing procedure.

As illustrated in FIG. 10, the first terminal apparatus (the smartphone 20) detects the second terminal apparatus (the tablet 30) (step S201). The second terminal apparatus transmits information responding to the detection (step S202). The information responding to the detection is, for example, information indicating to the first terminal apparatus that made the detection that the second terminal apparatus trusts communication from the first terminal apparatus or that the second terminal apparatus is ready to receive information transmitted thereto from the first terminal apparatus.

Subsequently, the first terminal apparatus transmits information about the registration request (step S203). The information about the registration request is, for example, information that checks to see whether or not it is permitted to make the registration request to the registering apparatus 100 and/or information that checks to see whether or not it is permitted to transmit, to the first terminal apparatus, information that is about the second terminal apparatus and is used for generating the registration request.

The second terminal apparatus transmits information responding to the registration request, to the first terminal apparatus (step S204). The information responding to the registration request is, for example, information permitting making the registration request to the registering apparatus 100 and/or information about the second terminal apparatus (the manufacture information and/or the information including the installed functions).

By using the information transmitted thereto as a response from the second terminal apparatus, the first terminal apparatus judges the trust of the second terminal apparatus on the basis of the information stored in the trust policy storage unit 151 (step S205). Further, the first terminal apparatus generates a registration request including certification indicating that the second terminal apparatus is trusted (step S206).

After that, the first terminal apparatus transmits the generated registration request to the registering apparatus 100 (step S207). The registering apparatus 100 judges the registration request transmitted thereto from the first terminal apparatus (step S208). Subsequently, when the certification indicating that the first terminal apparatus trusts the second terminal apparatus is trustworthy, the registering apparatus 100 registers the second terminal apparatus. In this situation, the registering apparatus 100 judges whether or not the certification indicating that the first terminal apparatus trusts the second terminal apparatus is trustworthy, on the basis of a signature or the like appended by the first terminal apparatus, for example.

After that, the registering apparatus 100 issues unique identification information (an ID) corresponding to the second terminal apparatus (step S209). The registering apparatus 100 transmits the issued ID to the first terminal apparatus (step S210).

The first terminal apparatus transmits the ID transmitted thereto from the registering apparatus 100, to the second terminal apparatus (step S211). The second terminal apparatus stores therein the ID transmitted thereto from the first terminal apparatus, as registration information (step S212). After this point in time, the second terminal apparatus is able to use the services or the like offered by the registering apparatus 100, by using the ID and the credential information transmitted thereto from the first terminal apparatus.

6. Modification Examples

The process performed by the registering system 1 described above may be carried out in various different forms other than those in the embodiment described above. Thus, in the following sections, other embodiments of the registering system 1 will be explained.

6-1. A Registering Process that Uses a Key Scheme

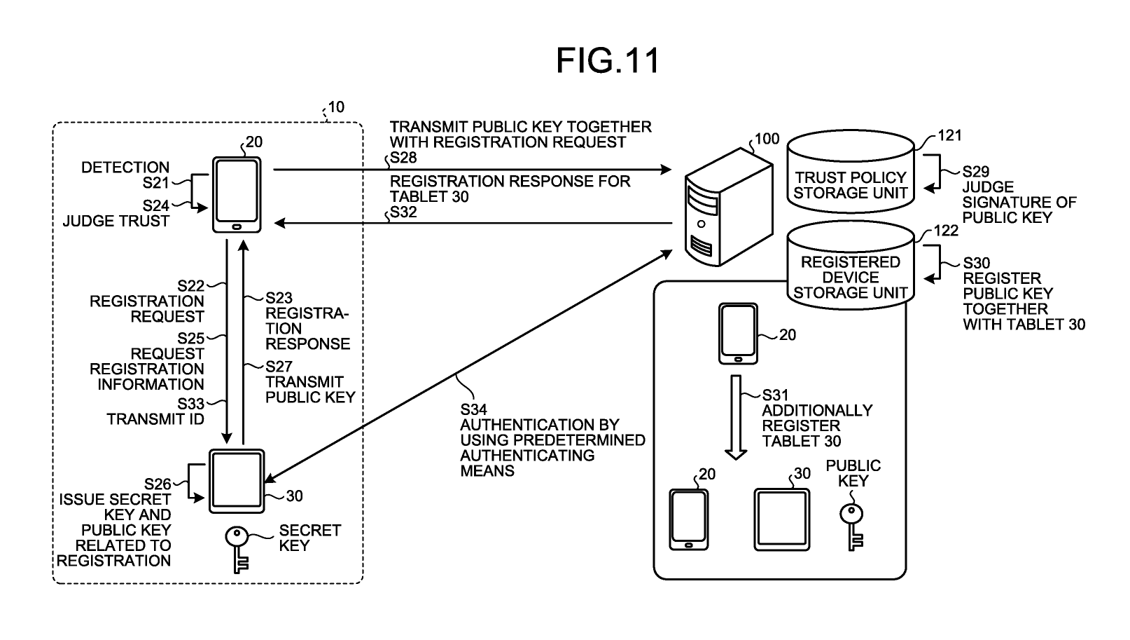

A registering process having a higher level of security may be performed on the user terminal 10 side, when performing the registering process with the registering apparatus 100. This aspect will be explained with reference to FIG. 11. FIG. 11 is a first drawing for explaining an example of the registering process according to a modification example. In the example illustrated in FIG. 11, it is assumed that the registering apparatus 100 has already registered the smartphone 20 as a first terminal apparatus.

The smartphone 20 detects the tablet 30 as a device positioned in the vicinity thereof (step S21). Further, the smartphone 20 transmits information about a registration request, to the tablet 30 (step S22). The tablet 30 responds to the request from the smartphone 20 (step S23). After that, on the basis of information transmitted thereto from the tablet 30, the smartphone 20 judges the trust of the tablet 30 (step S24). For example, according to the trust policy held therein, the smartphone 20 judges the trust of the tablet 30. As explained herein, the processes at steps S21 through S24 correspond to the processes at steps S05 through S08 illustrated in FIG. 1.

Subsequently, the smartphone 20 requests registration information from the tablet 30 (step S25). In this situation, the registration information requested by the smartphone 20 is information to be registered with the registering apparatus 100 from the tablet 30 side. In response, the tablet 30 performs a process of issuing a secret key and a public key related to the registration, as the registration information (step S26).

In this situation, the secret key and the public key issued by the tablet 30 are keys that work as a pair and that are used for performing an authentication process on the tablet 30. For example, the tablet 30 adopts a key scheme in which the secret key is held in the tablet 30, while the public key is held on the server side. In that situation, when the tablet 30 transmits information signed by using the secret key to the server side, if it is not possible, on the server side, to decrypt the information signed with the secret key by using the public key, the registering apparatus 100 will not authenticate the tablet 30.

For example, the tablet 30 arranges the issued secret key to be held in a storage region that is not accessible unless a specific authentication process is performed. The specific authentication process may be, for example, an authentication process performed by using biological information of the user who possesses the tablet 30. In that situation, unless the tablet 30 receives the biological information of the user, the tablet 30 is not able to access the secret key and is unable to use the information of the secret key. In other words, the tablet 30 is not able to be authenticated by the registering apparatus 100 until the tablet 30 receives the biological information of the user who is set as the user thereof. When adopting this authentication scheme, the tablet 30 does not need to perform the authentication process by transmitting the credential information such as the pass code to the registering apparatus 100. It is therefore possible to enhance the level of security related to the authentication process.

The tablet 30 transmits the issued public key to the smartphone 20 (step S27). In this situation, the tablet 30 may append a signature indicating that the public key was issued thereby, to the public key.

After that, the smartphone 20 transmits the public key to the registering apparatus 100, together with a registration request for the tablet 30 (step S28). In that situation, the smartphone 20 arranges the registration request to include information certifying that the smartphone 20 trusts the tablet 30 on the basis of the trust policy held therein.

When having received the registration request and the public key for the tablet 30 from the smartphone 20, the registering apparatus 100 analyzes the certification indicating that the tablet 30 is trusted by the smartphone 20. Further, the registering apparatus 100 judges the signature of the public key issued by the tablet 30 (step S29). For example, the registering apparatus 100 determines that the signature of the public key appended by the tablet 30 is trustworthy, for the reason that the tablet 30 that issued the public key is determined to be a trustworthy device on the basis of the trust policy held by the smartphone 20.

After that, the registering apparatus 100 registers the public key so as to be kept in correspondence with the tablet 30 (step S30). In other words, the registering apparatus 100 additionally registers therein the tablet 30 together with the public key (step S31).

The registering apparatus 100 transmits a response indicating that the tablet 30 has been registered, to the smartphone 20 (step S32). The smartphone 20 transmits the issued ID to the tablet 30 (step S33).

After this point in time, when the tablet 30 performs an authentication process with the registering apparatus 100, the tablet 30 performs the authentication process by using a predetermined authenticating means, instead of transmitting the credential information such as the pass code (step S34). In other words, to perform the authentication process, the tablet 30 requests the user to input the biological information. After that, when the user has input the biological information and the input information has been matched, the tablet 30 accesses the secret key. Subsequently, the tablet 30 generates information encrypted by appending a signature thereto while using the secret key. The tablet 30 transmits the generated information to the registering apparatus 100. The registering apparatus 100 decrypts the transmitted information by using the public key. When the decrypting process has been performed, the registering apparatus 100 determines that the tablet 30 is used by the true user and authenticates the tablet 30 on the basis of the process. In other words, without the need to directly transmit information such as the pass code, the tablet 30 is able to transfer the information certifying that the tablet 30 is used by the true user, to the registering apparatus 100. It is therefore possible to perform the authentication process having a high level of security.

As explained above, together with the registration request transmitted thereto from the smartphone 20 (the first terminal apparatus), the registering apparatus 100 receives the public key that is issued by the tablet 30 (the second terminal apparatus) and is used for the authenticating process of the tablet 30. Further, the registering apparatus 100 registers therein the public key so as to be kept in correspondence with the tablet 30. As a result of this process, the registering apparatus 100 is able to perform the registering process that is highly convenient and has a high level of security.

6-2. Communicating the Trust

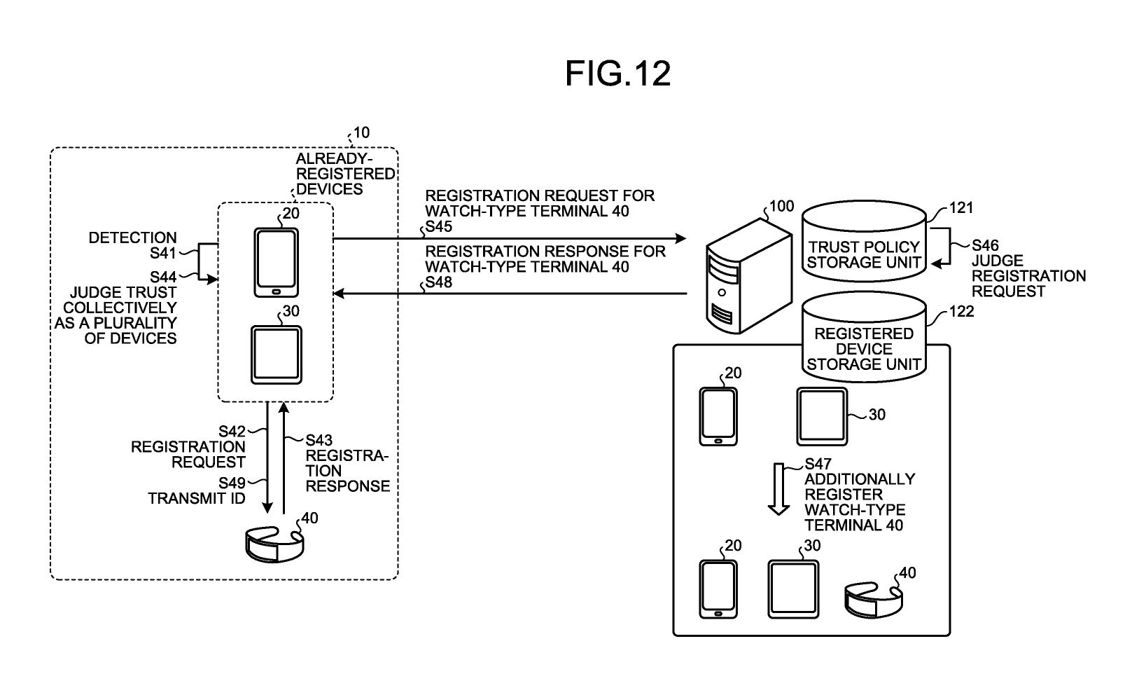

When generating the registration request to the registering apparatus 100, another arrangement is also acceptable in which, on the user terminal 10 side, two or more user terminals 10 judge another device. This aspect will be explained with reference to FIG. 12. FIG. 12 is a second drawing for explaining another example of a registering process according to another modification example. In the example illustrated in FIG. 12, it is assumed that the registering apparatus 100 has already registered the smartphone 20 as a first terminal apparatus and has already registered the tablet 30 as a second terminal apparatus.

Either the smartphone 20 or the tablet 30 detects a watch-type terminal 40 as a device positioned in the vicinity thereof (step S41). After that, the smartphone 20 or the tablet 30 transmits information about a registration request, to the watch-type terminal 40 (step S42). The watch-type terminal 40 responds to the request from the smartphone 20 or the tablet 30 (step S43). As explained herein, the processes at steps S41 through S43 correspond to the processes at steps S05 through S07 illustrated in FIG. 1.

After that, on the basis of the information transmitted thereto from the watch-type terminal 40, the smartphone 20 or the tablet 30 judges the trust of the watch-type terminal 40. In other words, the smartphone 20 or the tablet 30 judges the trust of the watch-type terminal 40, collectively as the plurality of devices (step S44). In that situation, the smartphone 20 or the tablet 30 may judge the trust of the watch-type terminal 40, in such a manner that one of the devices acts as a representative of the two. Alternatively, each of the two devices may judge the trust of the watch-type terminal 40, so that only when both of the devices determine that the watch-type terminal 40 is trusted, the watch-type terminal 40 is determined to be a trustworthy device. Further, the smartphone 20 or the tablet 30 may have mutually-the-same trust policy or may have mutually-different trust policies.

Further, the smartphone 20 or the tablet 30 transmits a registration request for the watch-type terminal 40 to the registering apparatus 100 (step S45). With respect to the registration request transmitted thereto from the smartphone 20 or the tablet 30, the registering apparatus 100 trusts the registration request on the basis that, for example, the smartphone 20 or the tablet 30 from which the registration request was transmitted has already been registered. Alternatively, the registering apparatus 100 may judge the reliability of the registration request on the basis of any of the various types of judgments described above (step S46).

After that, when the registration request is trusted, the registering apparatus 100 additionally registers the watch-type terminal 40 (step S47). In other words, the registering apparatus 100 additionally registers the watch-type terminal 40 into the trust network that has already been constructed by the smartphone 20 and the tablet 30.

Subsequently, the registering apparatus 100 transmits a response indicating that the watch-type terminal 40 has been registered, to the smartphone 20 or the tablet 30 (step S48). The smartphone 20 or the tablet 30 transmits the issued ID to the watch-type terminal 40 (step S49).

As explained above, the registering apparatus 100 receives the registration request that is transmitted from either the smartphone 20 (the first terminal apparatus) or the already-registered tablet 30 (the second terminal apparatus) and that is a request including the certification indicating that the third terminal apparatus (the watch-type terminal 40 in the example in FIG. 12) which is a device different from the smartphone 20 or the tablet 30 is trusted by the smartphone 20 or the tablet 30, on the basis of the trust policy held in the smartphone 20 or the tablet 30. After that, when having received the registration request, the registering apparatus 100 registers the third terminal apparatus. As explained herein, the registering apparatus 100 may accept the registration of yet another device, on the basis of the trust judgment made by one of the plurality of devices that have already been registered. With this arrangement, the registering apparatus 100 is able to perform the registering process that is highly convenient for the user.

Further, the registering apparatus 100 may be configured to receive a registration request that is transmitted from one of the certain devices of which reliability have been authenticated and that is a request including certification indicating that a fourth terminal apparatus (an arbitrary one of the user terminals 10) which is a device different from the certain devices that have already been registered, is trusted by at least two of the certain devices on the basis of a rule held by at least one of the certain devices. The registering apparatus 100 may be configured to register the fourth terminal apparatus, when having received the registration request.

In other words, the registering apparatus 100 may be configured so as to trust the registration request on the basis that the fourth terminal apparatus is trusted by at least two of the devices, instead of being trusted by one of the devices. In other words, the registering apparatus 100 assumes that it is impossible to ensure the reliability on the basis of a judging process performed by only one of the devices. The registering apparatus 100 is therefore configured to trust the fourth terminal apparatus only when two or more devices have performed the judging process thereon. With this arrangement, the registering apparatus 100 is able to further enhance the level of security in the registering process.

6-3. A Cooperation Process Performed Among Devices

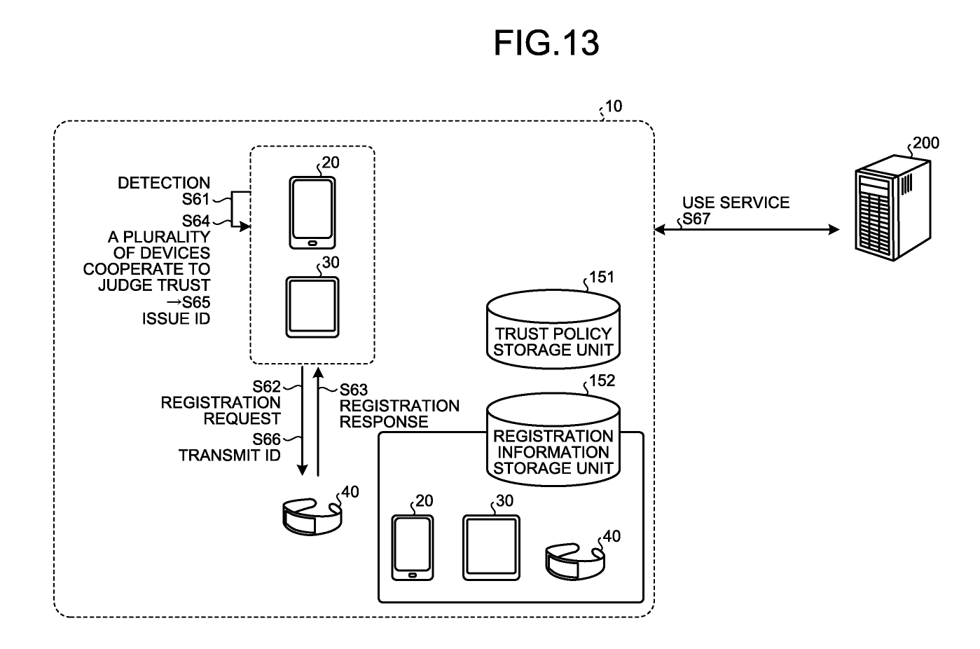

On the user terminal 10 side, it is also acceptable to perform the process of constructing a trust network among a plurality of devices or the process of additionally registering a new device, without involving the registering apparatus 100. This aspect will be explained, with reference to FIG. 13. FIG. 13 is a third drawing for explaining yet another example of a registering process according to yet another modification example. In the example illustrated in FIG. 13, it is assumed that a predetermined trust network has already been constructed by the smartphone 20 and the tablet 30 without involving the registering apparatus 100. Further, in the example illustrated in FIG. 13, it is assumed that either the smartphone 20 or the tablet 30 (i.e., a user terminal 10) further includes a registering unit 166, in addition to the configuration illustrated in FIG. 6.

The smartphone 20 or the tablet 30 detects the watch-type terminal 40 as a device positioned in the vicinity thereof (step S61). After that, the smartphone 20 or the tablet 30 transmits information about a registration request to the watch-type terminal 40 (step S62). The watch-type terminal 40 responds to the request from the smartphone 20 or the tablet 30 (step S63).

After that, the smartphone 20 or the tablet 30 judges the trust of the watch-type terminal 40, on the basis of the information transmitted thereto from the watch-type terminal 40. In other words, the smartphone 20 or the tablet 30 judges the trust of the watch-type terminal 40, collectively as the plurality of devices (step S64). In that situation, the smartphone 20 or the tablet 30 may judge the trust of the watch-type terminal 40, in such a manner that one of the devices acts as a representative of the two. Alternatively, each of the two devices may judge the trust of the watch-type terminal 40, so that only when both of the devices determine that the watch-type terminal 40 is trusted, the watch-type terminal 40 is determined to be a trustworthy device. Further, the smartphone 20 or the tablet 30 may have mutually-the-same trust policy or may have mutually-different trust policies.

After that, when having determined that the watch-type terminal 40 is a trustworthy device, the smartphone 20 or the tablet 30 additionally registers the watch-type terminal 40 into the trust network constructed by the smartphone 20 and the tablet 30. More specifically, the registering unit 166 included in the smartphone 20 or the tablet 30 additionally registers information about the watch-type terminal 40 into the registration information storage unit 152. In this situation, the registering unit 166 is a processing unit configured to perform processes corresponding to those performed by the registering unit 133 included in the registering apparatus 100.

After that, the smartphone 20 or the tablet 30 issues an ID to the watch-type terminal 40 (step S65). Subsequently, the smartphone 20 or the tablet 30 transmits the issued ID to the watch-type terminal 40 (step S66).

After this point in time, in addition to the smartphone 20 and the tablet 30, the watch-type terminal 40 is also able to perform, on a predetermined server, the same processes as can be performed by the smartphone 20 and the tablet 30. For example, when the smartphone 20 and the tablet 30 each have the right to access a server 200 offering a predetermined service, the watch-type terminal 40 also becomes able to use the server 200 (step S67).

As explained above, the smartphone 20 or the tablet 30 belonging to the trust network, which is a network formed among trusted apparatuses, detects the watch-type terminal 40, which is a predetermined device that does not belong to the trust network. After that, with respect to the detected watch-type terminal 40, at least one selected from between the smartphone 20 and the tablet 30 judges the reliability of the watch-type terminal 40, on the basis of the rule held in the smartphone 20 or the tablet 30. Subsequently, when having determined that the watch-type terminal 40 is a trustworthy device, the smartphone 20 or the tablet 30 registers the watch-type terminal 40 as a device belonging to the trust network.

As explained above, each of the user terminals 10 according to the embodiment has the functions of a registering apparatus and is capable of performing the process of additionally registering a predetermined device to the trust network. As a result of this process, the user is able to efficiently construct a network with the plurality of devices that he/she possesses. The trust policy storage unit 151 and the registration information storage unit 152 illustrated in FIG. 13 may be included in one selected from among the smartphone 20, the tablet 30, and the watch-type terminal 40 or may be included in each of all the devices.

6-4. Variations of the Processes

The processes performed by the user terminals 10 and the registering apparatus 100 in the embodiment described above may be carried out in different variations.

For example, when registering the second terminal apparatus, the registering apparatus 100 may be configured to adjust the process of registering the second terminal apparatus on the basis of information about the first terminal apparatus that trusts the second terminal apparatus. More specifically, the registering apparatus 100 obtains, as the information about the first terminal apparatus, a registration time period when the first terminal apparatus was registered by the registering apparatus 100, frequency with which first terminal apparatus accesses the registering apparatus 100 or a service server associated with the registering apparatus 100, a degree of rareness of the first terminal apparatus in the trust network (for example, the degree of rareness of the model of the terminal or the Operating System (OS) or the like included in the terminal, as compared among the plurality of terminals registered in the trust network), a level of security of the credentials used in the registration of the first terminal apparatus, and/or conditions in the trust policy used for the registration of the first terminal apparatus. After that, the registering apparatus 100 judges, for example, the registration time period being earlier, the frequency of access being higher, the degree of rareness being higher, the level of security of the credentials being higher, the conditions in the trust policy being more strict, or a combination of any of these. After that, the registering apparatus 100 may register the second terminal apparatus by, for example, prioritizing a registration request submitted by a first terminal apparatus having an earlier registration time period. Alternatively, for example, the registering apparatus 100 may perform the process of registering the second terminal apparatus, by determining that a registration request submitted from a first terminal apparatus having an earlier registration time period has a higher reliability.

Further, each of the user terminals 10 may be configured to perform the process of transferring the right to access a service or the like, when mutually judging the trust among the terminals and constructing a trust network.

For example, let us assume that the smartphone 20 and the tablet 30 both of which are allowed to access the service server 200 offering a service are present in a predetermined trust network. Further, let us assume that a fifth terminal apparatus and a sixth terminal apparatus are present which are both allowed to access, in addition to the service server 200, a service server 300 offering a service different from the service offered by the service server 200. In the present example, it is assumed that the fifth terminal apparatus and the sixth terminal apparatus are terminals of which reliability has been certified by the smartphone 20 or the tablet 30 and have been registered in the trust network.

In this situation, when a seventh terminal apparatus is to be newly registered, an arbitrary user terminal 10 (the smartphone 20 or the tablet 30) belonging to the trust network may be configured so as to register the seventh terminal apparatus into the trust network in such a manner that the seventh terminal apparatus becomes able to access the service server 300. In other words, when there is a trust network constructed by a plurality of terminals that are able to access at least one service, and the new terminal is to be added to the trust network, the user terminal 10 may be configured so as to perform the process of granting the access right, also with respect to the other service which is accessible by the other terminals that are not involved in the registering process (e.g., judging the trust policy) and that belong to the same trust network.

In the example described above, even though the smartphone 20 itself may never access the service server 300, the smartphone 20 may perform the process of granting the right to access the service server 300 to the newly-added seventh terminal apparatus, similarly to the fifth terminal apparatus and the sixth terminal apparatus. Alternatively, the smartphone 20 may be configured to be able to apply various conditions or selections indicating, for example, that the newly-added seventh terminal apparatus is not allowed to access (is not provided with the access right to) a service server which the other terminals are allowed to access. As explained herein, the user terminals 10 and the registering apparatus 100 may be configured to be able to change various conditions or to adjust the processes, without being limited by the processes described in the embodiment above.

Further, each of the user terminals 10 may be configured to perform the process of granting a right to arbitrarily exchange data among the terminals within a trust network, for example, without involving a server such as the registering apparatus 100.

Further, the registering apparatus 100 may be configured to perform a process of inviting user terminals 10 that wish to be registered. For example, the registering apparatus 100 invites registrations by broadcasting the invitation so as to discover (detect) terminals that are able to perform communication within the network or terminals that are positioned nearby. In other words, the registering apparatus 100 transmits the invitation for registering with the registering apparatus 100, to various user terminals 10.

Among the user terminals 10 that have received the invitation for the registration from the registering apparatus 100, one or more user terminals 10 that wish to be registered each transmit a registration request to the registering apparatus 100. In that situation, the registering apparatus 100 inquires an already-registered user terminal 10 of the trust of each of the user terminals 10 that transmitted the registration requests.

For example, let us discuss an example in which the smartphone 20 is a terminal that has already been registered with the registering apparatus 100, whereas the tablet 30 is a terminal that newly requests a registration with the registering apparatus 100. In that situation, the registering apparatus 100 requests the smartphone 20 to judge the trust of the tablet 30. According to the trust policy held therein, the smartphone 20 verifies the trust of the tablet 30. After that, when having verified that the tablet 30 is a trustworthy terminal, the smartphone 20 transmits information indicating that the tablet 30 is trustworthy, to the registering apparatus 100. On the basis of the information transmitted thereto from the smartphone 20, the registering apparatus 100 registers the tablet 30.

As explained above, for example, the registering apparatus 100 may be configured to invite registrations from a large number of unspecified terminals and to perform the process of causing the already-registered terminal to judge the trustability of each of the terminals that responded to the invitation. With this arrangement, the registering apparatus 100 is able to efficiently expand the trust network, while ensuring security.

6-5. A Judging Process Performed by the User

To the processes described in the embodiment above, a judging process performed by the user of the user terminals 10 may be added. For example, the user may activate a predetermined application program (e.g., an application program realized by the registering program) in the smartphone 20 and the tablet 30 at the same time so as to cause the smartphone 20 and the tablet 30 to perform the detecting process with each other. Further, when the user terminals 10 each have an item such as “a judgment made by the user” as a trust policy, the user is able to arrange the judgment of his/her own to be included in the judgment factors used by the user terminals 10 to judge the trust of other devices.

6-6. The User Terminals

In the embodiment above, the exemplary configuration of any of the user terminals 10 was explained with reference to FIG. 6; however, the user terminals 10 each do not necessarily need to have all the constituent elements illustrated in FIG. 6. Examples of the user terminals 10 include not only smart devices such as the smartphone 20 and the tablet 30 described above, but also other various devices such as the watch-type terminal 40 and an eyeglass-type terminal having a communicating function as well as a heartbeat measuring device that stores therein heartbeats of the user. In that situation, the user terminals 10 each do not necessarily have to receive an input from the user, but may have functions to automatically obtain information about the user and to transmit the obtained information to a communication network, or the like. In other words, the user terminals 10 do not necessarily need to have the configuration illustrated in FIG. 6, as long as each of the user terminals 10 is a device having a predetermined communicating function such as a function to realize what is called the Internet of Things (IoT).

With respect to a device to be newly registered, the registering apparatus 100 and the user terminals 10 may be configured to make a difference depending on the functions the device has, for example. In other words, the registering apparatus 100 and the user terminals 10 may be configured to flexibly adjust the trust policy depending on the functions of the device to be registered, for example, by arranging the trust policy to indicate that devices that are not configured to receive an input from the user thereof will not be allowed to be registered.

6-7. Communication with the Registering Apparatus

In the embodiment described above, for instance, FIG. 1 illustrates the example in which, with respect to the second terminal apparatus (the tablet 30) trusted by the first terminal apparatus (the smartphone 20), the issuance of the ID or the like is received from the registering apparatus 100 via the first terminal apparatus during the registration process. However, possible embodiments are not limited to this example. Another arrangement is acceptable in which, after the registration request is transmitted from the first terminal apparatus, communication is established between the second terminal apparatus and the registering apparatus 100.

6-8. The Registration of the First Terminal Apparatus

In the embodiment described above, the example is explained in which the first terminal apparatus is registered with the registering apparatus 100; however, possible embodiments are not limited to this example. The first terminal apparatus does not necessarily have to be registered with the registering apparatus 100. In that situation, the first terminal apparatus is, for example, a device holding a trust policy having a standard equivalent to that of the registering apparatus 100, and the first terminal apparatus performs the process of judging the trust of the second terminal apparatus. After that, the first terminal apparatus transmits, to the registering apparatus 100, a registration request having appended thereto the certification indicating that the second terminal apparatus is a trustworthy device and is thus able to request the registration of the second terminal apparatus. In other words, in the registering system 1, the first terminal apparatus itself does not necessarily have to be registered with the registering apparatus 100 and may function as a terminal that judges the trust of the second terminal apparatus.

7. A Hardware Configuration

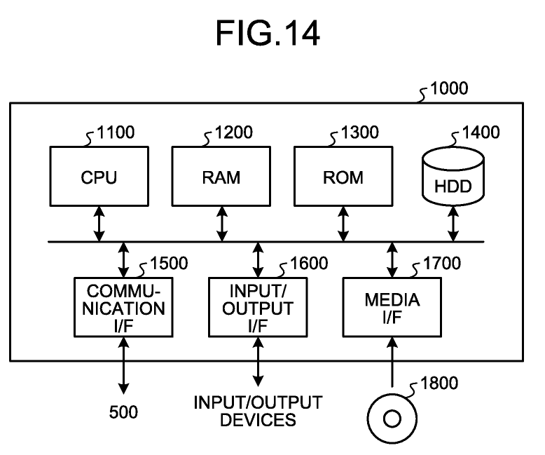

The registering apparatus 100 according to the embodiment described above may be realized by a computer 1000 configured as illustrated in FIG. 14, for example. In the following sections, the registering apparatus 100 will be explained as an example. FIG. 14 is a hardware configuration diagram illustrating an example of the computer 1000 that realizes functions of the registering apparatus 100. The computer 1000 includes a CPU 1100, a RAM 1200, a Read-Only Memory (ROM) 1300, a Hard Disk Drive (HDD) 1400, a communication interface (I/F) 1500, an input/output interface (I/F) 1600, and a media interface (I/F) 1700.

The CPU 1100 is configured to control various functional units by operating on the basis of computer programs (hereinafter, “program”) each of which is stored in either the ROM 1300 or the HDD 1400. The ROM 1300 stores therein a boot program executed by the CPU 1100 when the computer 1000 is started up as well as programs and the like that are dependent on the hardware of the computer 1000.

The HDD 1400 stores therein programs executed by the CPU 1100 and data and the like used by the executed programs. The communication interface 1500 is configured to receive data from another device via a communication network 500 (corresponding to the network N illustrated in FIG. 2), to forward the received data to the CPU 1100, and to transmit data generated by the CPU 1100 to another device via the communication network 500.

The CPU 1100 is configured to control, via the input/output interface 1600, output devices such as a display device and a printer, as well as input devices such as a keyboard and a mouse. The CPU 1100 obtains data from the input devices via the input/output interface 1600. Further, the CPU 1100 outputs generated data to the output devices via the input/output interface 1600.

The media interface 1700 is configured to read a program or data stored in a recording medium 1800 and to provide the read program or data for the CPU 1100 via the RAM 1200. The CPU 1100 loads the program from the recording medium 1800 into the RAM 1200 via the media interface 1700 and executes the loaded program. For example, the recording medium 1800 may be an optical recording medium such as a Digital Versatile Disk (DVD) or a Phase change rewritable Disk (PD), an opto-magnetic recording medium such as a Magneto-Optical (MO) disk, a tape medium, a magnetic recording medium, a semiconductor memory, or the like.

For example, when the computer 1000 functions as the registering apparatus 100 according to the embodiment, the CPU 1100 included in the computer 1000 realizes the functions of the controlling unit 130 by executing the program loaded into the RAM 1200. Further, the HDD 1400 has stored therein the data in the storage unit 120. The CPU 1100 included in the computer 1000 executes these programs by reading the programs from the recording medium 1800. Alternatively, the CPU 1100 may obtain these programs from another apparatus via the communication network 500.

8. Others

With regard to the processes explained in the embodiment above, it is acceptable to manually perform all or a part of the processes described as being performed automatically. Conversely, by using a method that is publicly known, it is also acceptable to automatically perform all or a part of the processes described as being performed manually. Further, unless noted otherwise, it is acceptable to arbitrarily modify any of the processing procedures, specific names, and various information including various types of data and parameters that are presented in the above text and the drawings. For example, the various types of information illustrated in the drawings are not limited by the illustrated pieces of information.

The constituent elements of the devices and the apparatuses illustrated in the drawings are based on functional concepts. Thus, it is not necessary to physically configure the constituent elements as indicated in the drawings. In other words, the specific modes of distribution and integration of the devices and the apparatuses are not limited to those illustrated in the drawings. It is acceptable to functionally or physically distribute or integrate all or a part of the devices and the apparatuses in any arbitrary units, depending on various loads and the status of use. For example, the judging unit 132 and the registering unit 133 illustrated in FIG. 3 may be integrated together. As another example, the information stored in the storage unit 120 may be stored in a storage device provided on the outside via the network N.

Further, for example, in the embodiment described above, the example is explained in which the registering apparatus 100 performs the receiving process of receiving the registration request and the registering process of registering the user terminals 10. However, the registering apparatus 100 described above may be separated into a receiving apparatus that performs the receiving process and a registering apparatus that performs the registering process. In other words, the registering apparatus 100 may be separated into a front-end server configured to transmit and receive information to and from the user terminals 10 and a back-end server configured to perform processes on the basis of received information. In that situation, the processes performed by the registering apparatus 100 according to the embodiment are realized by the registering system 1 including an apparatus that realizes the functions of the front-end server and another apparatus that realizes the functions of the back-end server.

Further, it is possible to combine together any of the embodiments and the modification examples described above as appropriate, as long as no conflict arises among the contents of the processes.

9. Advantageous Effects

As explained above, the registering apparatus 100 according to the embodiment includes the receiving unit 131 and the registering unit 133. The receiving unit 131 receives the registration request that is transmitted from the first terminal apparatus (the smartphone 20 in the embodiment) of which the reliability (the trust) has been verified on the basis of the predetermined rule and that is a request including the certification indicating that the second terminal apparatus (the tablet 30 in the embodiment) is trusted by the first terminal apparatus on the basis of the rule held in the first terminal apparatus. After that, the registering unit 133 registers the second terminal apparatus, when the receiving unit 131 has received the registration request.

In this manner, the registering apparatus 100 according to the embodiment registers the second terminal apparatus trusted by the first terminal apparatus of which the reliability is ensured. As a result of this process, the user is able to save the trouble of causing all the devices he/she possesses to access the registering apparatus 100 and to perform the registering process. The user is therefore able to perform the registering process conveniently. In other words, the registering apparatus 100 is able to perform the registering process with an excellent level of convenience for the user.

Further, the registering unit 133 registers the second terminal apparatus when the certification included in the registration request certifies that the second terminal apparatus is trusted by the first terminal apparatus on the basis of the rule having the standard equivalent to that of the predetermined rule.

In this manner, the registering apparatus 100 according to the embodiment registers the second terminal apparatus that is trusted according to the standard equivalent to the standard (the trust policy) used when the registering apparatus 100 trusted the first terminal apparatus. As a result, the registering apparatus 100 is able to perform the registering process also on the second terminal apparatus, while ensuring the security guaranteed by the registering apparatus 100.

Further, via the first terminal apparatus, the registering unit 133 issues, to the second terminal apparatus, the unique identification information that is issued at the time of the registration and that is used when the second terminal apparatus accesses the registering apparatus.

In this manner, the registering apparatus 100 according to the embodiment is able to forward the information or the like issued at the time of the registration to the second terminal apparatus via the first terminal apparatus. As a result, for example, even if it is difficult for the device to directly communicate with the registering apparatus 100, going through the first terminal apparatus makes it possible to perform the registering process without any problem. In other words, the registering apparatus 100 is able to realize a flexible registering process.

Further, together with the registration request transmitted thereto from the first terminal apparatus, the receiving unit 131 receives the public key that is issued by the second terminal apparatus and is used for the authentication process performed on the second terminal apparatus. The registering unit 133 registers the public key so as to be kept in correspondence with the second terminal apparatus.

In this manner, because the registering apparatus 100 according to the embodiment adopts the authentication process that uses the predetermined key scheme, the registering apparatus 100 may be configured to receive the public key from the second terminal apparatus and to register the received public key so as to be kept in correspondence with the second terminal apparatus. As a result, the registering apparatus 100 is able to perform the registering process with a higher level of security.

Further, the registering apparatus 100 according to the embodiment further includes the judging unit 132 that judges the reliability of the registration request. The registering unit 133 registers the second terminal apparatus, when the judging unit 132 has determined that the registration request is trustworthy.

In this manner, the registering apparatus 100 according to the embodiment may be configured to perform the predetermined judging process with respect to the registration request received from the first terminal apparatus. As a result, the registering apparatus 100 is able to enhance the level of security related to the registering process.

The judging unit 132 judges whether or not the certification included in the registration request is based on the predetermined communication established between the first terminal apparatus and the second terminal apparatus. The registering unit 133 registers the second terminal apparatus, when the judging unit 132 has determined that the certification included in the registration request is based on the predetermined communication established between the first terminal apparatus and the second terminal apparatus.

In this manner, the registering apparatus 100 according to the embodiment may be configured to judge whether or not the second terminal apparatus is a trustworthy device, by judging the communication state between the first terminal apparatus and the second terminal apparatus. As a result, because the registering apparatus 100 is able to ensure a certain level of reliability with respect to the second terminal apparatus, the registering apparatus 100 is able to perform a secure registering process.

Further, the receiving unit 131 receives the registration request that is transmitted from one selected from between the first terminal apparatus and the second terminal apparatus registered by the registering unit 133 and that is a request including the certification indicating that the third terminal apparatus (the watch-type terminal 40 in the embodiment) being different from the one selected from between the first terminal apparatus and the second terminal apparatuses is trusted by the one selected from between the first terminal apparatus and the second terminal apparatus on the basis of the rule held in the one selected from between the first terminal apparatus and the second terminal apparatus. The registering unit 133 registers the third terminal apparatus, when the receiving unit 131 has received the registration request.

In this manner, the registering apparatus 100 according to the embodiment may be configured to receive the registration of the further different device, on the basis of the judgment of the trust made by the one of the plurality of devices that have already been registered. As a result of this process, the user is able to efficiently register the plurality of devices he/she possesses. In other words, the registering apparatus 100 is able to offer the registering process that has a high level of convenience for the user.

Further, the receiving unit 131 receives the registration request that is transmitted from one selected from among the first terminal apparatus and terminal apparatuses registered by the registering unit 133 and that is a request including the certification indicating that a fourth terminal apparatus (the arbitrary one of the user terminals 10) being different from the certain already-registered terminal apparatuses is trusted by at least two of the certain terminal apparatuses on the basis of the rule held in at least one of the certain terminal apparatuses. The registering unit 133 registers the fourth terminal apparatus, when the receiving unit 131 has received the registration request.

In this manner, the registering apparatus 100 according to the embodiment may be configured to trust the registration request on the basis that the fourth terminal apparatus (the terminal apparatus that the user wishes to have newly registered) is trusted, not only by one of the already-registered terminal apparatuses, but at least two of the terminal apparatuses. With this arrangement, the registering apparatus 100 is able to further enhance the security in the registering process.

Further, the registering unit 133 registers the first terminal apparatus, on the basis of the predetermined rule (the trust policy) that is one selected from between: the rule regarding the functions installed in the first terminal apparatus; and the rule regarding the manufacture of the first terminal apparatus.

In this manner, the registering apparatus 100 according to the embodiment is able to judge the reliability of the terminal apparatus on the basis of the functions installed in the terminal apparatus and the manufacture information thereof. As a result, the registering apparatus 100 is able to ensure a certain level of reliability in the registering processes.

Further, each of the user terminals 10 according to the embodiment is a terminal apparatus of which the reliability has been verified on the basis of the predetermined rule held in the registering apparatus 100 and includes the detecting unit 162, the judging unit 163, and the transmitting unit 165. The detecting unit 162 detects the second terminal apparatus. With respect to the second terminal apparatus detected by the detecting unit 162, the judging unit 163 judges the reliability of the second terminal apparatus on the basis of the rule having the standard equivalent to that of the predetermined rule. The transmitting unit 165 transmits the registration request to the registering apparatus 100, when the judging unit 132 has determined that the second terminal apparatus is a trustworthy terminal apparatus, the registration request being a request that includes the certification indicating that the second terminal apparatus is trusted and requesting the registering apparatus 100 to register the second terminal apparatus.

In this manner, each of the user terminals 10 according to the embodiment is able to judge whether or not the second terminal apparatus is suitable as a device to be registered by the registering apparatus 100, by judging the reliability of the second terminal apparatus while using the trust policy corresponding to the trust policy that was used when the user terminal 10 was registered. Further, the user terminal 10 transmits the registration request together with the certification indicating that the second terminal apparatus has been determined to be suitable, to the registering apparatus 100. In other words, when the user terminal 10 is used, it is possible to make the registration request for the second terminal apparatus to the registering apparatus 100, without the second terminal apparatus directly communicating with the registering apparatus 100. As a result, the user terminal 10 is able to enhance the level of convenience for the user in relation to the registering process.

Further, an example of the registering method according to the embodiment that is implemented by one or more of the plurality of terminal apparatuses belonging to the trust network, which is a network formed among trusted apparatuses, includes the detecting step, the judging step, and the registering step. At the detecting step, a predetermined terminal apparatus that does not belong to the trust network is detected. At the judging step, with respect to the predetermined terminal apparatus detected at the detecting step, the reliability of the predetermined terminal apparatus is judged by at least one of the plurality of terminal apparatuses on the basis of the rule held in each of the plurality of terminal apparatuses. When the predetermined terminal apparatus has been determined to be a trustworthy terminal apparatus at the judging step, the predetermined terminal apparatus is registered as a terminal apparatus belonging to the trust network at the registering step.

In this manner, according to the registering method according to the embodiment, the plurality of terminal apparatuses cooperate with one another to judge the terminal apparatus to be registered into the trust network formed among the terminal apparatuses and to perform the registering process of the terminal apparatus. As a result of this process, for example, even when a user possesses a plurality of terminal apparatuses and wishes to add a new terminal apparatus, the user is able to use, on the new terminal apparatus, the same network environment as the one used on the terminal apparatuses he/she has been using, without the need to perform any particular process. As a result, the registering method according to the embodiment is able to enhance the level of convenience in the registering process.

The configurations described above may be realized by the registering system 1. In other words, in the registering system 1 including the registering apparatus 100, the first terminal apparatus, and the second terminal apparatus, the first terminal apparatus of which the reliability has been verified on the basis of the predetermined rule held in the registering apparatus 100 includes: the detecting unit 162 that detects the second terminal apparatus; the judging unit 163 that, with respect to the second terminal apparatus detected by the detecting unit 162, judges the reliability of the second terminal apparatus on the basis of the rule having the standard equivalent to that of the predetermined rule; and the transmitting unit 165 that transmits the registration request to the registering apparatus 100 when the judging unit 163 has determined that the second terminal apparatus is a trustworthy terminal apparatus, the registration request being a request that includes the certification indicating that the second terminal apparatus is trusted and requesting the registering apparatus 100 to register the second terminal apparatus. Further, the registering apparatus 100 includes: the receiving unit 131 that receives the registration request transmitted thereto by the transmitting unit 165; and the registering unit 133 that registers the second terminal apparatus, when the receiving unit 131 has received the registration request. With this configuration, the registering system 1 achieves an advantageous effect where it is possible to perform the registering process with an excellent level of convenience.

Some of the embodiments of the present application have thus been explained in detail, with reference to the accompanying drawings; however, the described embodiments are only examples. It is possible to carry out the present invention not only in the embodiments described in the sections disclosing the invention, but also in other embodiments obtained by applying various modifications and improvements thereto on the basis of knowledge of a person skilled in the art.

Further, the terms “section”, “module”, and “unit” used in the above explanations may be replaced with “means” or “circuit”. For example, the receiving unit may alternatively be referred to as a receiving means or a receiving circuit.

According to at least one aspect of the embodiments, an advantageous effect is achieved where it is possible to perform the registering process with an excellent level of convenience.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A registering apparatus comprising:
a receiving unit that receives a registration request that is transmitted from a first terminal apparatus of which reliability has been verified on a basis of a predetermined rule and that is a request including certification indicating that a second terminal apparatus is trusted by the first terminal apparatus on a basis of a rule held in the first terminal apparatus; and
a registering unit that registers the second terminal apparatus, when the receiving unit has received the registration request.

2. The registering apparatus according to claim 1, wherein
the registering unit registers the second terminal apparatus, when the certification included in the registration request certifies that the second terminal apparatus is trusted by the first terminal apparatus on the basis of the rule having a standard equivalent to that of the predetermined rule.

3. The registering apparatus according to claim 1, wherein
via the first terminal apparatus, the registering unit issues, to the second terminal apparatus, unique identification information that is issued at a time of the registration and that is to be used when the second terminal apparatus accesses the registering apparatus.

4. The registering apparatus according to claim 1, wherein
together with the registration request transmitted thereto from the first terminal apparatus, the receiving unit receives a public key that is issued by the second terminal apparatus and is used for an authentication process performed on the second terminal apparatus, and
the registering unit registers the public key so as to be kept in correspondence with the second terminal apparatus.

5. The registering apparatus according to claim 1, further comprising:
a judging unit that judges reliability of the registration request, wherein
the registering unit registers the second terminal apparatus, when the judging unit has determined that the registration request is trustworthy.

6. The registering apparatus according to claim 5, wherein
the judging unit judges whether or not the certification included in the registration request is based on predetermined communication established between the first terminal apparatus and the second terminal apparatus, and
the registering unit registers the second terminal apparatus, when the judging unit has determined that the certification included in the registration request is based on the predetermined communication established between the first terminal apparatus and the second terminal apparatus.

7. The registering apparatus according to claim 1, wherein
the receiving unit receives a registration request that is transmitted from one selected from between the first terminal apparatus and the second terminal apparatus registered by the registering unit and that is a request including certification indicating that a third terminal apparatus being different from the one selected from between the first terminal apparatus and the second terminal apparatus is trusted by the one selected from between the first terminal apparatus and the second terminal apparatus on a basis of a rule held in the one selected from between the first terminal apparatus and the second terminal apparatus, and
the registering unit registers the third terminal apparatus, when the receiving unit has received the registration request.

8. The registering apparatus according to claim 7, wherein
the receiving unit receives a registration request that is transmitted from one selected from among the first terminal apparatus and terminal apparatuses registered by the registering unit and that is a request including certification indicating that a fourth terminal apparatus being different from certain already-registered terminal apparatuses is trusted by at least two of the certain terminal apparatuses on a basis of a rule held in at least one of the certain terminal apparatuses, and
the registering unit registers the fourth terminal apparatus, when the receiving unit has received the registration request.

9. The registering apparatus according to claim 1, wherein
the registering unit registers the first terminal apparatus, on the basis of the predetermined rule that is one selected from between: a rule regarding a function installed in the first terminal apparatus; and a rule regarding manufacture of the first terminal apparatus.

10. A terminal apparatus of which reliability has been verified on a basis of a predetermined rule held in a registering apparatus, the terminal apparatus comprising:
a detecting unit that detects a second terminal apparatus;
a judging unit that judges, with respect to the second terminal apparatus detected by the detecting unit, reliability of the second terminal apparatus on a basis of a rule having a standard equivalent to that of the predetermined rule; and
a transmitting unit that transmits a registration request to the registering apparatus when the judging unit has determined that the second terminal apparatus is a trustworthy terminal apparatus, the registration request being a request that includes certification indicating that the second terminal apparatus is trusted and requesting the registering apparatus to register the second terminal apparatus.

11. A registering method implemented by a registering apparatus, comprising:
receiving a registration request that is transmitted from a first terminal apparatus of which reliability has been verified on a basis of a predetermined rule and that is a request including certification indicating that a second terminal apparatus is trusted by the first terminal apparatus on a basis of a rule held in the first terminal apparatus; and
registering the second terminal apparatus, when the registration request has been received.

12. A registering method implemented by one or more of a plurality of terminal apparatuses belonging to a trust network that is a network formed among trusted apparatuses, the registering method comprising:
detecting a predetermined terminal apparatus that does not belong to the trust network;
with respect to the predetermined terminal apparatus detected at the detecting, causing at least one of the plurality of terminal apparatuses to judge reliability of the predetermined terminal apparatus on a basis of a rule held in each of the plurality of terminal apparatuses; and
registering the predetermined terminal apparatus as a terminal apparatus belonging to the trust network, when the predetermined terminal apparatus has been determined to be a trustworthy terminal apparatus at the judging.

13. A non-transitory computer readable storage medium having stored therein a registering computer program causing a computer to execute a process comprising:
receiving a registration request that is transmitted from a first terminal apparatus of which reliability has been verified on a basis of a predetermined rule and that is a request including certification indicating that a second terminal apparatus is trusted by the first terminal apparatus on a basis of a rule held in the first terminal apparatus; and
registering the second terminal apparatus, when the registration request has been received at the receiving.
